(19) United States
(12) Patent Application Publication
(10) Pub. No.: US 2026/0116417 A1
(43) Pub. Date: Apr. 30, 2026

(54) SYSTEMS AND METHODS FOR MULTI-MODAL DRIVER FATIGUE AND DROWSINESS DETECTION WITH ADAPTIVE CONFIGURATION AND CONTINUOUS LEARNING

(71) Applicant: MOTIVE TECHNOLOGIES, INC., San Francisco, CA (US)

(72) Inventors: Ali HASSAN, Lahore (PK); Hamza RAWAL, Lahore (PK); Mohammad Daniyal SHAIQ, San Francisco, CA (US); Ahmed ALI, Lahore (PK); Afsheen Rafaqat ALI, Gujranwala (PK); Sachin LOMTE, San Francisco, CA (US); Muhammad FAISAL, Jhawarian (PK); Devin SMITH, San Francisco, CA (US); Syed Wajahat Ali Shah KAZMI, Lahore (PK)

(21) Appl. No.: 19/375,010

(22) Filed: Oct. 30, 2025

Related U.S. Application Data
(60) Provisional application No. 63/714,339, filed on Oct. 31, 2024.

(51) Int. Cl. B60W 50/14; B60W 40/08; G06V 10/82; G06V 20/56; G06V 20/59; G06V 40/10

(52) U.S. Cl. CPC B60W 50/14; B60W 40/08; G06V 10/82; G06V 20/56; G06V 20/597; G06V 40/10; B60W 2040/0827; B60W 2420/403; B60W 2520/10; B60W 2540/229; B60W 2556/10

(57) ABSTRACT

A system is described including a telematics sensor configured to record telematics data related to a vehicle; one or more camera sensors situated within a dash-mounted camera housing installed within the vehicle, the one or more camera sensors configured to capture video frames; an atomic event identifier including one or more of a driver-facing perception ML module, a road-facing perception ML module, a telemetry ML module and a personalized driving context and history module; and an edge processor situated within the dash-mounted camera housing, the edge processor configured to: receive the video frames and the telematics data; determine whether a vehicle speed exceeds a predetermined threshold based on an output of the telematics sensor; when the vehicle speed exceeds the predetermined threshold, process the video frames and telematics data through the atomic event identifier to detect one or more atomic events; calculate a Driver Fatigue Index (DFI) score by aggregating detected atomic events with configurable weights; generate a drowsiness/fatigue event when the DFI score exceeds a configurable threshold; and trigger an in-cab alert in response to the generated drowsiness/fatigue event.

### CROSS-REFERENCE TO RELATED APPLICATIONS

This application claims the benefit of Provisional Patent Application No. 63/714,339 filed Oct. 31, 2024, which is incorporated by reference in its entirety.

### BACKGROUND

Driver drowsiness and fatigue represent significant safety challenges in commercial vehicle operations, contributing to thousands of accidents, injuries, and fatalities annually. Studies indicate that drowsy driving may be involved in up to 20% of all vehicle crashes, with commercial drivers facing elevated risks due to long hours, monotonous highway driving, and irregular schedules. The economic impact extends beyond human casualties to include property damage, cargo loss, increased insurance costs, and regulatory penalties.

### BRIEF DESCRIPTION OF THE DRAWINGS

FIG. 1 is a block diagram illustrating a driver drowsiness detection system according to some of the disclosed embodiments.

FIG. 1A is a block diagram illustrating an atomic event identifier according to some of the disclosed embodiments.

FIG. 1B is a block diagram illustrating an atomic event identifier according to some of the disclosed embodiments.

FIG. 1C is a block diagram illustrating an atomic event identifier according to some of the disclosed embodiments.

FIG. 2 is a flow diagram illustrating a method for detecting driver drowsiness using multi-modal behavioral analysis according to some of the disclosed embodiments.

FIG. 3 is a flow diagram illustrating a state machine operation flow for drowsiness detection according to some of the disclosed embodiments.

FIG. 4 is a flow diagram illustrating a method for calculating a Driver Fatigue Index (DFI) according to some of the disclosed embodiments.

FIG. 5 is a flow diagram illustrating a method for generating synthetic training data for drowsiness detection according to some of the disclosed embodiments.

FIG. 6 is a flow diagram illustrating a method for knowledge distillation to compress drowsiness detection models for edge deployment according to some of the disclosed embodiments.

FIG. 7 is a flow diagram illustrating a method for multi-modal processing of driver, road, and vehicle data for comprehensive drowsiness detection according to some of the disclosed embodiments.

FIG. 8 is a flow diagram illustrating a method for parameter update and continuous improvement of drowsiness detection systems according to some of the disclosed embodiments.

FIG. 9 is a flow diagram illustrating a method for fleet configuration of drowsiness detection systems according to some of the disclosed embodiments.

FIG. 10 is a block diagram of a computing device according to some embodiments of the disclosure.

### DETAILED DESCRIPTION

Traditional approaches to drowsiness detection have relied on various technologies, each with inherent limitations. Systems focusing solely on image captures of the driver's face require high-resolution imaging and specific mounting positions to reliably detect eye closure or facial expressions. These systems often struggle with varying lighting conditions, driver eyewear, and diverse facial features. Conversely, driving pattern methods that monitor lane position or steering patterns can identify impaired vehicle control but may generate false positives in construction zones or during legitimate lane changes. Wearable devices that track physiological signals like heart rate or EEG patterns provide direct biological measurements but face adoption challenges due to driver comfort and compliance issues.

The deployment environment for commercial vehicle drowsiness detection presents unique challenges. Edge computing devices in vehicles must operate within strict power and thermal constraints while processing continuous video streams in real-time. Network connectivity for cloud-based processing is often intermittent or unavailable during vehicle operation. The diversity of commercial vehicle types, from urban delivery vans to long-haul trucks, creates varying cabin configurations and operational patterns that affect system design.

Existing drowsiness detection systems typically employ fixed algorithms with predetermined thresholds that cannot adapt to individual driver characteristics or changing operational contexts. Night shift drivers may exhibit different fatigue patterns than daytime operators. Urban delivery routes with frequent stops present different drowsiness risks than highway transportation. Seasonal variations, weather conditions, and geographic factors all influence both driver fatigue patterns and detection system performance.

The false positive problem remains a critical barrier to widespread adoption of drowsiness detection technology. Drivers quickly lose trust in systems that generate frequent alerts for normal behaviors like checking mirrors, adjusting controls, or brief glances at instrumentation. Conversely, systems tuned to minimize false positives may miss genuine drowsiness indicators, failing in their primary safety mission. This balance between sensitivity and specificity becomes more complex when considering the variety of activities drivers legitimately perform while operating vehicles.

Data availability presents another fundamental challenge. Drowsiness-related driving events are relatively rare compared to normal driving, making it difficult to collect sufficient real-world examples for developing and validating detection algorithms. Certain drowsiness behaviors, such as microsleep episodes or specific patterns of degraded vehicle control, may occur so infrequently that traditional data collection methods cannot capture adequate samples for machine learning approaches. Privacy concerns and regulatory restrictions further limit the ability to collect and share driver monitoring data across organizations.

Current systems also lack mechanisms for continuous improvement based on field performance. Once deployed, detection algorithms remain static despite accumulating operational data that could enhance their accuracy. Fleet managers have limited ability to customize detection parameters for their specific operational needs or to incorporate lessons learned from actual drowsiness incidents. This inflexibility prevents systems from evolving to address emerging challenges or taking advantage of new insights about fatigue patterns.

The computational requirements of sophisticated drowsiness detection algorithms often exceed the capabilities of affordable edge computing hardware suitable for vehicle deployment. High-accuracy models developed in research environments may require powerful GPUs or extensive memory resources that are impractical for widespread commercial deployment. This creates a gap between what is technically possible in laboratory settings and what can be economically deployed across large vehicle fleets.

Regulatory frameworks for commercial driver hours of service provide maximum driving time limits but cannot account for individual variations in fatigue susceptibility or the quality of rest periods. Drivers may be legally compliant with hours of service while still experiencing dangerous levels of drowsiness due to factors such as sleep disorders, medication effects, or circadian rhythm disruptions. Electronic logging devices track driving time but provide no direct measurement of driver alertness or fitness for duty.

Existing driver drowsiness detection systems face a fundamental technical limitation in distinguishing between drowsiness-related behaviors and purposeful driver activities that produce similar visual patterns. When a driver's head tilts downward, current vision-based detection algorithms cannot reliably determine whether this movement indicates dangerous head drooping from fatigue or intentional actions such as checking instruments, adjusting controls, or interacting with permitted devices. This ambiguity leads to excessive false positive alerts that degrade system utility. Additionally, current systems employ static detection parameters that cannot adapt to varying operational contexts or incorporate field performance data for improvement. The large model architectures used in existing systems require computational resources exceeding typical automotive-grade edge processors, preventing deployment of sophisticated detection algorithms. Furthermore, the scarcity of real-world drowsiness event data limits the training of machine learning models, particularly for rare but critical behaviors such as microsleep episodes. These technical constraints result in drowsiness detection systems that either generate excessive false alerts or miss genuine safety risks, while remaining computationally impractical for widespread edge deployment.

The disclosed technology solves these technical challenges through a flexible multi-modal processing architecture that can be implemented using multiple approaches optimized for different deployment requirements. The system processes video streams from driver-facing and road-facing cameras along with vehicle telematics data to detect behavioral and vehicular indicators of drowsiness. An atomic event identifier analyzes these inputs as well as driver or vehicle contextual data (e.g., hours driving, previous driving behaviors, time of day, etc.) to generate standardized atomic events indicating drowsy or fatigued conditions. The atomic event identifier may be implemented using a state machine approach with task-specific neural network heads and rule-based temporal logic that provides interpretable detection with configurable thresholds; a temporal neural network approach that operates on feature embeddings accumulated across sliding time windows to capture subtle behavioral progressions; or an end-to-end trainable approach that employs spatiotemporal neural networks to jointly optimize feature extraction and behavioral classification. All implementations incorporate object interaction filtering to disambiguate drowsiness behaviors from purposeful driver activities, suppressing false positive alerts when drivers interact with cabin objects. To address computational constraints, the system implements knowledge distillation that compresses large teacher models into compact student models suitable for edge deployment, reducing parameter counts by an order of magnitude while maintaining detection accuracy. The system generates synthetic training data through multiple modalities including image-to-video generation, region-of-interest editing, and pose-based synthesis, creating diverse examples of rare drowsiness behaviors. A continuous learning pipeline incorporates human-validated field events to automatically update detection parameters, weights, and decay factors through cloud-based optimization. The Driver Fatigue Index aggregates weighted behavioral indicators with temporal decay functions, providing nuanced drowsiness assessment beyond binary classification. This technical architecture enables accurate drowsiness detection within edge computing constraints while continuously improving through field deployment experience, with flexibility to select the optimal implementation approach based on available computational resources, deployment context, and performance requirements.

In some implementations, the techniques described herein relate to a system including: a telematics sensor configured to record telematics data related to a vehicle; one or more camera sensors situated within a dash-mounted camera housing installed within the vehicle, the one or more camera sensors configured to capture video frames; an atomic event identifier including one or more of a driver-facing perception ML module, a road-facing perception ML module, a telemetry ML module and a personalized driving context and history module; an edge processor situated within the dash-mounted camera housing, the edge processor configured to: receive the video frames and the telematics data; determine whether a vehicle speed exceeds a predetermined threshold based on an output of the telematics sensor; when the vehicle speed exceeds the predetermined threshold, process the video frames and telematics data through the atomic event identifier to detect one or more atomic events; calculate a Driver Fatigue Index (DFI) score by aggregating detected atomic events with configurable weights; generate a drowsiness/fatigue event when the DFI score exceeds a configurable threshold; and trigger an in-cab alert in response to the generated drowsiness/fatigue event.

In some implementations, the techniques described herein relate to a system, wherein the atomic event identifier includes: a unified driver model including a neural network backbone configured to extract hierarchical features from driver-facing video frames; a unified road model including a neural network backbone configured to extract hierarchical features from road-facing video frames; a plurality of task-specific detection heads configured to process the hierarchical features of unified driver model, the plurality of task-specific detection heads including at least one of: an object detection head, a scene/action classification head, a head pose estimation head or a body pose estimation head; a plurality of task-specific detection heads configured to process the hierarchical features of unified road model, the plurality of task-specific detection heads including at least one of: an object detection head, a scene classification head, depth estimation head, 3D cuboid detection, lane detection head, or segmentation head; a plurality of state machines configured to receive outputs from the plurality of task-specific detection heads and apply rule-based temporal logic to validate behavioral patterns across consecutive frames; and wherein the atomic events are generated based on outputs from the plurality of state machines.

In some implementations, the techniques described herein relate to a system, wherein the atomic event identifier includes: a unified driver model including a neural network backbone configured to extract feature embeddings from driver-facing video frames; a unified road model including a neural network backbone configured to extract feature embeddings from road-facing video frames; a first temporal neural network configured to receive the feature embeddings from the unified driver model and classify behavioral patterns by analyzing evolution of the feature embeddings over time; a second temporal neural network configured to receive the feature embeddings from the unified road model and classify behavioral patterns by analyzing evolution of the feature embeddings over time; and wherein the atomic events are generated based on outputs from the temporal neural network.

In some implementations, the techniques described herein relate to a system, wherein the atomic event identifier includes: an end-to-end trainable neural network configured to directly process video frames to generate behavioral indicator classifications, wherein the end-to-end trainable neural network employs spatiotemporal processing that simultaneously captures spatial visual patterns and temporal evolution without separate feature extraction and temporal aggregation stages.

In some implementations, the techniques described herein relate to a system, wherein the plurality of state machines are configured to: maintain tracking of atomic events across consecutive frames; increment a respective atomic event counter when its confidence score exceeds a preconfigured threshold; validate that the respective atomic event behavior duration exceeds a second preconfigured threshold; and apply a voting filter requiring a threshold number of frames within the second preconfigured threshold to contain valid detections.

In some implementations, the techniques described herein relate to a system, wherein calculating the DFI score includes: applying behavior-specific weights to each detected behavioral indicator based on correlation with fatigue-related accidents; applying contextual factors including at least one of: prior driving context, trip duration, time of day, or previous atomic events; and applying a decay function to reduce influence of past atomic events over time.

In some implementations, the techniques described herein relate to a system, the edge processor further configured to: select between at least one of linear decay calculation, an exponential decay calculation, or an ML-based decay calculation based on a configuration parameter; and maintain different decay rates for different types of atomic events.

In some implementations, the techniques described herein relate to a system, the edge processor further configured to: record video evidence of the drowsiness/fatigue event; upload the video evidence and event metadata to a cloud processing system; receive updated detection parameters from the cloud processing system, the updated parameters derived from human validation of previous behavioral events; and apply the updated detection parameters to subsequent drowsiness/fatigue detection operations.

In some implementations, the techniques described herein relate to a system, the edge processor further configured to: continuously receive real-time contextual data pertaining to the vehicle's operating environment, the contextual data including at least one of: current weather conditions, time of day, road classification, vehicle speed, or traffic density; and dynamically adjust a plurality of operational thresholds within the drowsiness detection system based on the received real-time contextual data, wherein the plurality of operational thresholds includes at least the drowsiness score threshold, one or more behavioral indicator sensitivity thresholds, and an alert generation threshold, thereby adapting the system's responsiveness to the current driving context.

In some implementations, the techniques described herein relate to a system, the edge processor further configured to: receive configuration updates from a fleet management system, the configuration updates specifying at least one of: detection sensitivity thresholds, enabled atomic events, decay rates, or alert modalities; validate the configuration updates through simulation against historical event data; and apply the validated configuration updates to modify drowsiness detection parameters without interrupting ongoing vehicle operation.

In some implementations, the techniques described herein relate to a system, further including a cloud-based synthetic data generation system configured to: identify atomic events having insufficient representation in training data; search one or more data repositories using one or more machine learning models to identify content containing the identified atomic events; generate synthetic training data for atomic events determined to have insufficient real-world examples, wherein the synthetic training data generation includes modifying existing image or video data to introduce the behavioral indicators; and update parameters of the atomic event identifier based on training data including both the identified content from the data repositories and the generated synthetic training data.

In some implementations, the techniques described herein relate to a system, wherein the atomic event identifier further includes: a telematics processing module configured to receive time-series vehicle operational data from the telematics sensor; and one or more state machines configured to analyze temporal patterns in the vehicle operational data to identify anomalous driving behaviors, wherein the edge processor is configured to incorporate outputs from the one or more state machines as inputs for calculating the DFI score.

In some implementations, the techniques described herein relate to a system, wherein the one or more state machines are configured to: receive longitudinal vehicle speed data over a plurality of time intervals; analyze the received vehicle speed data to identify speed variation patterns indicative of driver fatigue, the patterns including at least one of: inconsistent acceleration, erratic deceleration, or failure to maintain consistent cruising speed; generate a speed-based fatigue metric based on the identified speed variation patterns; and wherein the edge processor utilizes the speed-based fatigue metric as an additional input to corroborate and refine the DFI score calculation.

In some implementations, the techniques described herein relate to a method including: receiving, by an edge processor situated within a dash-mounted camera housing installed within a vehicle, video frames captured by one or more camera sensors situated within the dash-mounted camera housing and telematics data recorded by a telematics sensor of the vehicle; determining, by the edge processor, whether a vehicle speed exceeds a predetermined threshold based on an output of the telematics sensor; when the vehicle speed exceeds the predetermined threshold, process the video frames and telematics data through an atomic event identifier to detect one or more atomic events, the atomic event identifier including one or more of a driver-facing perception ML module, a road-facing perception ML module, a telemetry ML module and a personalized driving context and history module; calculating, by the edge processor, a Driver Fatigue Index (DFI) score by aggregating detected atomic events with configurable weights; generating, by the edge processor, a drowsiness/fatigue event when the DFI score exceeds a configurable threshold; and triggering, by the edge processor, an in-cab alert in response to the generated drowsiness/fatigue event.

In some implementations, the techniques described herein relate to a method, wherein the atomic event identifier includes: a unified driver model including a neural network backbone configured to extract hierarchical features from driver-facing video frames; a unified road model including a neural network backbone configured to extract hierarchical features from road-facing video frames; a plurality of task-specific detection heads configured to process the hierarchical features of unified driver model, the plurality of task-specific detection heads including at least one of: an object detection head, a scene/action classification head, a head pose estimation head or a body pose estimation head; a plurality of task-specific detection heads configured to process the hierarchical features of unified road model, the plurality of task-specific detection heads including at least one of: an object detection head, a scene classification head, depth estimation head, 3D cuboid detection, lane detection head, or segmentation head; a plurality of state machines configured to receive outputs from the plurality of task-specific detection heads and apply rule-based temporal logic to validate behavioral patterns across consecutive frames; and wherein the atomic events are generated based on outputs from the plurality of state machines.

In some implementations, the techniques described herein relate to a system, wherein the plurality of state machines are configured to: maintain tracking of atomic events across consecutive frames; increment a respective atomic event counter when its confidence score exceeds a preconfigured threshold; validate that the respective atomic event behavior duration exceeds a second preconfigured threshold; and apply a voting filter requiring a threshold number of frames within the second preconfigured threshold to contain valid detections.

In some implementations, the techniques described herein relate to a method, wherein the atomic event identifier includes: a unified driver model including a neural network backbone configured to extract feature embeddings from driver-facing video frames; a unified road model including a neural network backbone configured to extract feature embeddings from road-facing video frames; a first temporal neural network configured to receive the feature embeddings from the unified driver model and classify behavioral patterns by analyzing evolution of the feature embeddings over time; a second temporal neural network configured to receive the feature embeddings from the unified road model and classify behavioral patterns by analyzing evolution of the feature embeddings over time; and wherein the atomic events are generated based on outputs from the temporal neural network.

In some implementations, the techniques described herein relate to a method, wherein the atomic event identifier includes: an end-to-end trainable neural network configured to directly process video frames to generate behavioral indicator classifications, wherein the end-to-end trainable neural network employs spatiotemporal processing that simultaneously captures spatial visual patterns and temporal evolution without separate feature extraction and temporal aggregation stages.

In some implementations, the techniques described herein relate to a method, wherein the atomic event identifier further includes: a telematics processing module configured to receive time-series vehicle operational data from the telematics sensor; and one or more state machines configured to analyze temporal patterns in the vehicle operational data to identify anomalous driving behaviors, wherein the edge processor is configured to incorporate outputs from the one or more state machines as inputs for calculating the DFI score.

In some implementations, the techniques described herein relate to a non-transitory computer-readable storage medium for tangibly storing computer program instructions capable of being executed by an edge processor situated within a dash-mounted camera housing installed within a vehicle, the computer program instructions defining steps of: receiving, by the edge processor, video frames captured by one or more camera sensors situated within the dash-mounted camera housing and telematics data recorded by a telematics sensor of the vehicle; determining, by the edge processor, whether a vehicle speed exceeds a predetermined threshold based on an output of the telematics sensor; when the vehicle speed exceeds the predetermined threshold, process the video frames and telematics data through an atomic event identifier to detect one or more atomic events, the atomic event identifier including one or more of a driver-facing perception ML module, a road-facing perception ML module, a telemetry ML module and a personalized driving context and history module; calculating, by the edge processor, a Driver Fatigue Index (DFI) score by aggregating detected atomic events with configurable weights; generating, by the edge processor, a drowsiness/fatigue event when the DFI score exceeds a configurable threshold; and triggering, by the edge processor, an in-cab alert in response to the generated drowsiness/fatigue event.

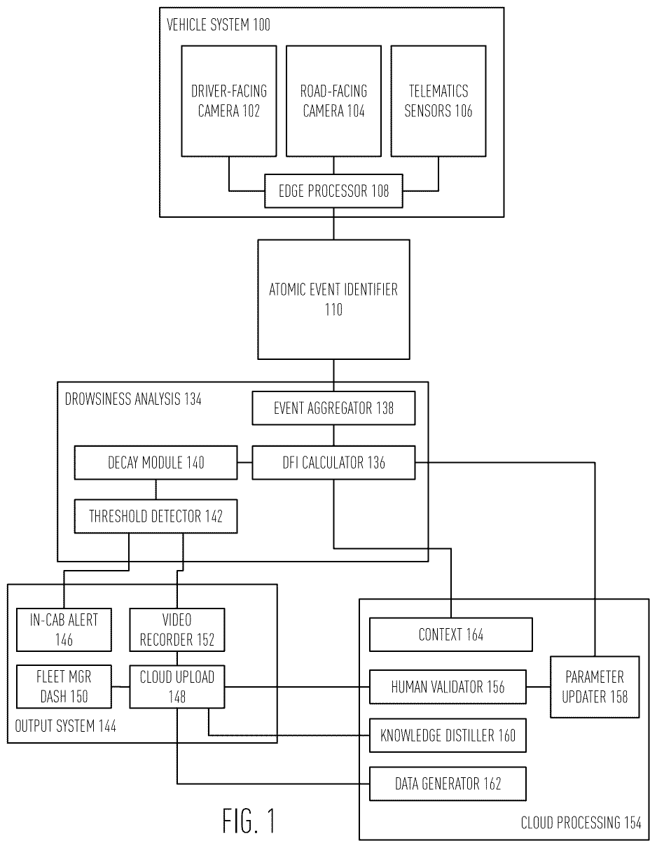

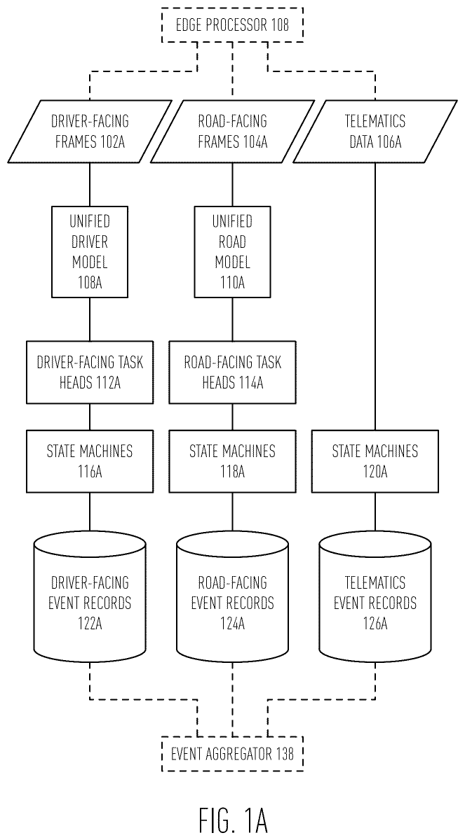

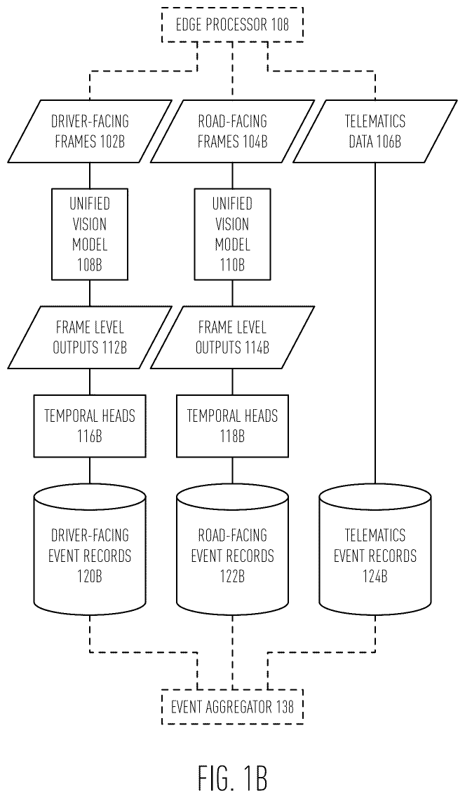

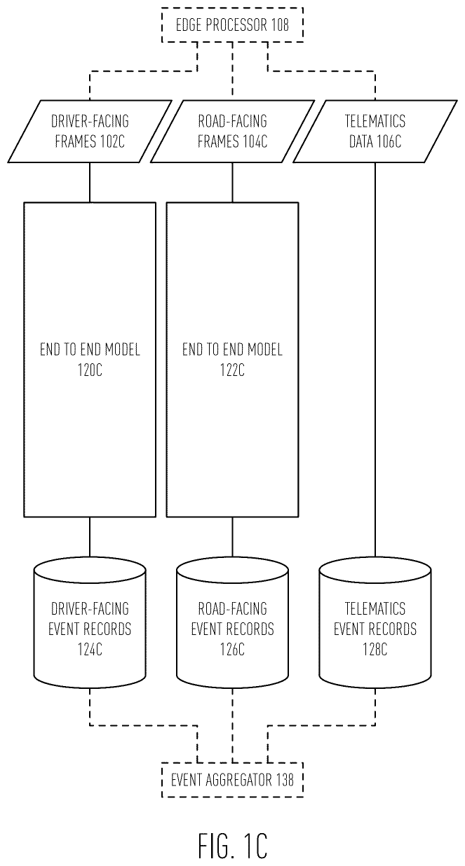

FIG. 1 is a block diagram illustrating a driver drowsiness detection system according to some of the disclosed embodiments.

In the illustrated embodiment, a vehicle system 100 includes an edge processor 108. The edge processor 108 is communicatively coupled to peripheral devices including, without limitation, a driver-facing camera 102, a road-facing camera 104, and telematics sensors 106. In some implementations, the vehicle system may include a dash-mounted camera housing the driver-facing camera 102, road-facing camera 104 and edge processor 108. In some implementations, the telematics sensors 106 may be installed within the vehicle itself. In other implementations, the telematics sensors 106 may be implemented within the dash-mounted camera housing as well. As illustrated, the edge processor 108 interfaces with various processing modules and subsystems for detecting driver drowsiness through multi-modal analysis. Certainly, additional sensors and peripherals may be integrated with vehicle system 100 and the disclosure is not limited to only the illustrated components. In some implementations, vehicle system 100 may be integrated into commercial vehicles for fleet safety monitoring. For example, the driver-facing camera 102 may be mounted to capture the entire vehicle cabin including both driver and passenger areas, while the road-facing camera 104 may be mounted to capture the forward view from the vehicle.

Edge processor 108 receives data from and sends data to the various peripherals and performs real-time processing operations thereon. Edge processor 108 may perform numerous safety-related functions not described herein and only a subset of those operations related to drowsiness detection are described in detail in the disclosure. While the following disclosure discusses drowsiness detection, the systems and methods may equally be applied to other detections such as fatigue detection or similar detections. As such, the operations of edge processor 108 are not limited to those described herein.

Edge processing includes an atomic event identifier 110 that processes incoming data streams from driver-facing camera 102, road-facing camera 104, and telematics sensors 106 to detect behavioral and vehicular indicators of driver drowsiness. In one implementation, atomic event identifier 110 may be situated within a dashcam. In another implementation, atomic event identifier 110 may be situated in another device within a vehicle. In yet another implementation, atomic event identifier 110 may be situated remote to a vehicle (e.g., in a cloud environment). In another implementation, some features of atomic event identifier 110 may be within a vehicle while others may be remote to a vehicle. The atomic event identifier 110 analyzes video frames and sensor data to identify atomic events such as yawning, sleeping, microsleeping, blink rate, rubbing eyes, slouching, stretching, head drooping, eye closure, touching one's face, heading nodding, lack of body movements, lane drift, lane swerving, speed patterns, brake patterns, or other abnormal vehicle behaviors. The specific types of drowsiness or fatigue events are not limited herein and others herein may fall within the scope of the disclosure. The atomic event identifier 110 may be implemented using various architectural approaches depending on computational constraints, deployment requirements, and desired detection characteristics. Regardless of implementation approach, the atomic event identifier 110 outputs standardized atomic events that serve as inputs to downstream drowsiness analysis components. These atomic events include associated metadata such as timestamps, confidence scores, event durations, and contextual information that enables comprehensive fatigue assessment.

In some implementations, the atomic event identifier 110 employs a unified model architecture with task-specific neural network heads for parallel behavioral analysis. The unified driver model processes driver-facing video frames through a convolutional neural network backbone to extract hierarchical features, which are then analyzed by specialized detection heads for tasks including object detection, scene classification, and body pose estimation. Similarly, the unified road model processes road-facing video frames to extract lane boundaries, vehicle positions, and trajectory information. The outputs from these task-specific heads are processed by state machines that implement temporal logic for tracking behavioral patterns across consecutive frames, applying configurable thresholds for event duration, confidence scores, and voting mechanisms to validate sustained behaviors. This approach enables precise control over detection sensitivity through adjustable parameters while maintaining computational efficiency suitable for edge deployment. Details of this approach are described in FIG. 1A.

In alternative implementations, the atomic event identifier 110 utilizes temporal neural networks that operate on feature embeddings extracted from the unified model backbone rather than on the outputs of task-specific heads. This architecture accumulates feature embeddings across a sliding temporal window, typically spanning several seconds of video data, and processes these aggregated embeddings through recurrent networks, temporal convolutional networks, or attention-based mechanisms to directly classify behavioral patterns. The temporal models learn to identify drowsiness indicators by analyzing the evolution of visual patterns over time, capturing subtle behavioral progressions that may not be apparent in individual frames. This approach can detect complex temporal dependencies and behavioral sequences while potentially reducing the number of intermediate processing stages compared to state machine implementations. Details of this approach are described in FIG. 1B.

In further implementations, the atomic event identifier 110 comprises a single end-to-end trainable neural network that directly processes input video frames and telematics data to generate atomic event classifications without separate feature extraction and temporal aggregation stages. This unified architecture learns optimal feature representations and temporal patterns simultaneously through joint training on drowsiness detection objectives. The end-to-end model may employ three-dimensional convolutional networks, video transformers, or other architectures designed for spatiotemporal analysis to capture both spatial visual patterns and their temporal evolution in a single processing pipeline. This approach can potentially achieve superior detection accuracy by optimizing all processing stages jointly, though it may require more substantial computational resources and training data compared to modular implementations. Details of this approach are described in FIG. 1C.

The filtered detection results are provided to drowsiness analysis 134, which performs comprehensive analysis to determine overall driver fatigue state. An event aggregator 138 combines multiple detection events, considering their temporal relationships and co-occurrence patterns. For instance, event aggregator 138 may identify that two yawning events occurred within a three-minute window, or that a yawning event was followed by a distraction event within one minute.

A DFI calculator 136 receives aggregated events and computes a DFI score. The DFI calculator 136 applies configurable weights to different event types based on their correlation with drowsiness risk. For example, microsleep events may receive higher weights than isolated yawning events. The calculated DFI score is processed by a decay module 140, which applies time-based decay functions to account for the diminishing relevance of past events. The decay module 140 may implement various decay strategies, such as linear or exponential decay, with different decay rates for different event types.

In some implementations, the DFI calculator 136 can additionally utilize context 164 stored in cloud processing 154 to influence the DFI score. In some implementations, context 164 may include vehicle or driver context data including, but not limited to, a number of continuous hours driven by the driver, previous fatigue history, time of driving (day/night, etc), previous unsafe driving behaviors. In some implementations, this context 165 can be treated similar to atomic event indicators (i.e., scored in a similar manner). In other implementations, the context 164 can be used as a weighting or biasing value to increase the DFI score. For example, a number of continuous hours driven or a previous fatigue history can be used to increase the “baseline” for computing a DFI score. A user having a longer number of continuous hours may trigger a drowsiness event than another having less continuous hours.

A threshold detector 142 continuously monitors the decayed DFI score against configurable thresholds. When the DFI score exceeds a threshold, indicating significant drowsiness risk, the threshold detector 142 triggers appropriate system responses through output system 144.

Output system 144 manages various system responses to detected drowsiness. An in-cab alert 146 may generate audio, visual, or haptic warnings to alert the driver. A video recorder 152 captures and stores video evidence of drowsiness events for later review. The recorded video is transmitted via cloud upload 148 to remote systems, where it becomes accessible through a fleet manager dashboard 150. This enables fleet safety managers to monitor driver alertness across their vehicle fleet and identify drivers who may need additional rest or training.

Cloud processing 154 provides advanced processing capabilities that enhance the edge-based detection system. A human validator 156 reviews uploaded drowsiness events to verify detection accuracy, providing ground truth data for system improvement. Based on validation results, a parameter updater 158 calculates optimized parameters for the detection algorithms, such as adjusted weights for different behaviors or modified decay rates. These updated parameters are transmitted back to the DFI calculator 136 in the edge system, enabling continuous improvement of detection accuracy.

Additionally, cloud processing 154 includes a knowledge distiller 160 that compresses large, accurate cloud-based models into smaller models suitable for edge deployment. This enables the system to benefit from sophisticated cloud-trained models while maintaining real-time performance on resource-constrained edge processors. A data generator 162 creates synthetic training data for rare drowsiness behaviors using generative models, addressing the challenge of limited real-world drowsiness data.

The architecture illustrated in FIG. 1 provides a comprehensive solution for driver drowsiness detection that combines real-time edge processing with cloud-based learning and validation. The multi-modal approach, incorporating visual, behavioral, and vehicle telemetry data, enables robust detection while the object interaction filter reduces false positives. The continuous learning loop through cloud processing ensures the system improves over time, while maintaining the low-latency response necessary for driver safety applications.

FIG. 1A illustrates a detailed block diagram of the atomic event identifier 110 implemented using a state machine approach according to some of the disclosed embodiments. This implementation architecture represents a modular design that separates feature extraction, task-specific detection, and temporal pattern analysis into distinct processing stages, enabling precise control over detection behavior through configurable parameters.

As illustrated, edge processor 108 receives input data streams from three parallel sources within the vehicle system. Driver-facing frames 102A are captured by the driver-facing camera, providing continuous visual monitoring of the driver's facial expressions, head position, body posture, and interactions with cabin objects. Road-facing frames 104A are captured by the road-facing camera, enabling analysis of lane positioning, vehicle trajectory, and surrounding traffic conditions. Telematics data 106A is collected from vehicle sensors, providing real-time measurements of operational parameters including speed, acceleration, braking force, and steering angle. These three complementary data streams provide comprehensive coverage of both driver state and vehicle control quality.

The driver-facing frames 102A are processed through a unified driver model 108A that serves as the feature extraction backbone. In some implementations, the unified driver model 108A comprises a convolutional neural network utilizing proven architectures such as ResNet, EfficientNet, or MobileNet that balance detection accuracy with computational efficiency suitable for edge deployment. The backbone network processes raw pixel data through multiple convolutional layers to extract hierarchical feature representations, progressing from low-level edges and textures in early layers to high-level semantic patterns in deeper layers. These extracted features capture visual information about facial configuration, head orientation, body position, and cabin environment that serves as input for subsequent task-specific analysis.

The features extracted by unified driver model 108A are provided to driver-facing task heads 112A, which comprise multiple specialized neural network heads trained for distinct computer vision tasks. In some implementations, the task heads include an object detection head that identifies and localizes objects within the cabin such as mobile phones, food items, beverages, and vehicle controls; a scene classification head that categorizes overall cabin activity patterns; and a body pose estimation head that predicts keypoint locations for facial landmarks and body joints. Each task head is optimized specifically for its detection objective, enabling parallel analysis of multiple behavioral aspects from the shared feature representations. The task heads generate frame-level outputs including classification probabilities, bounding box coordinates, keypoint positions, and confidence scores that represent instantaneous assessments of visual patterns in individual frames.

Similarly, road-facing frames 104A are processed through a unified road model 110A designed for road scene understanding. The unified road model 110A extracts features relevant to lane detection, vehicle tracking, and trajectory analysis using a convolutional backbone architecture analogous to the driver-facing model. The extracted features are provided to road-facing task heads 114A, which include specialized heads for lane boundary detection, vehicle object detection, and distance estimation. The lane detection head outputs polynomial coefficients or point sequences describing lane markings, enabling precise measurement of vehicle position within the lane. The vehicle detection head identifies and tracks surrounding vehicles, providing bounding boxes and tracking identifiers. The distance estimation head predicts metric distances to detected objects, supporting assessment of following distances and safety margins.

The outputs from driver-facing task heads 112A are provided to state machines 116A, which implement rule-based temporal logic for behavioral pattern detection. Unlike the temporal neural networks employed in FIG. 1B, the state machines 116A utilize explicitly programmed logic with configurable thresholds and validation criteria. In some implementations, separate state machines track distinct drowsiness indicators such as yawning frequency, eye closure duration, and head position changes. Each state machine maintains internal state variables that accumulate evidence across consecutive frames, applying validation rules that may include minimum confidence score thresholds, required behavior duration thresholds, and voting filters that demand a specified percentage of frames within a time window contain valid detections. For example, a yawning state machine may require that yawning confidence exceeds 0.8 in at least 70% of frames within a 3-second window, with the detected mouth aperture persisting for at least 2.5 seconds. This rule-based approach provides interpretable detection logic where individual threshold parameters can be adjusted to tune system sensitivity and specificity.

Similarly, outputs from road-facing task heads 114A are provided to state machines 118A that implement temporal logic for vehicle control quality assessment. These state machines analyze lane position trajectories to detect weaving or drift patterns, track steering correction frequency and magnitude, and identify anomalous vehicle movements that may indicate degraded driver control. The state machines apply configurable thresholds for parameters such as maximum allowable lane position variance, minimum duration for drift events, and required correlation between multiple indicators.

The telematics data 106A is processed through dedicated state machines 120A that analyze time-series patterns in vehicle operational parameters. These state machines detect abnormal patterns such as unjustified speed variations, erratic braking behavior, or inconsistent steering inputs that may indicate driver inattention. The telematics state machines implement logic that accounts for normal driving context, distinguishing between legitimate speed changes due to traffic conditions and concerning variations that suggest loss of driver focus.

The validated outputs from the state machines are organized into three separate event record databases: driver-facing event records 122A, road-facing event records 124A, and telematics event records 126A. These databases maintain structured logs of detected atomic events with associated metadata including timestamps, confidence scores, event durations, and the specific detection criteria that were satisfied. The separation into distinct databases enables independent optimization of each detection modality while maintaining clear provenance of detection sources.

Finally, event aggregator 138 receives atomic events from all three record databases and performs comprehensive drowsiness assessment through multi-modal correlation analysis. The event aggregator analyzes temporal relationships between events from different modalities, recognizing that simultaneous or closely-sequenced events across multiple channels provide stronger drowsiness evidence than isolated indicators.

The state machine approach illustrated in FIG. 1A offers several advantages for commercial deployment. The modular architecture enables independent development and optimization of each processing stage. The explicit rule-based logic provides interpretability, allowing system operators to understand why specific detections occurred and adjust thresholds based on operational experience. The configurable parameters support customization for different vehicle types, operational contexts, and fleet safety policies without requiring model retraining. This implementation approach provides a balance between sophisticated multi-task visual analysis and transparent, adjustable detection logic suitable for safety-critical applications.

FIG. 1B illustrates a detailed block diagram of the atomic event identifier 110 implemented using a temporal model approach according to some of the disclosed embodiments. This implementation architecture represents an alternative to the state machine approach, providing the capability to detect complex behavioral patterns through learned temporal representations rather than rule-based logic.

As illustrated, edge processor 108 receives input data streams from multiple sources within the vehicle system. Driver-facing frames 102B are captured by the driver-facing camera, providing continuous visual monitoring of the driver's behavioral state. Road-facing frames 104B are captured by the road-facing camera, enabling analysis of vehicle trajectory and lane positioning. Telematics data 106B is collected from vehicle sensors, providing measurements of speed, acceleration, steering angle, and other operational parameters. These three parallel data streams provide complementary perspectives on driver alertness and vehicle control quality.

The driver-facing frames 102B are processed through a unified vision model 108B specifically optimized for driver behavior analysis. In some implementations, the unified vision model 108B comprises a convolutional neural network backbone that extracts hierarchical feature representations from raw pixel data. The backbone architecture may utilize proven designs such as ResNet, EfficientNet, or MobileNet, selected based on the balance between detection accuracy and computational efficiency required for edge deployment. The unified vision model 108B generates frame level outputs 112B that represent intermediate feature embeddings rather than final behavioral classifications. These embeddings capture rich visual information about facial expressions, head position, body posture, and cabin environment across multiple levels of abstraction within the neural network.

Similarly, road-facing frames 104B are processed through a unified vision model 110B designed for road scene understanding. This model extracts features relevant to lane detection, vehicle tracking, and trajectory analysis. The unified vision model 110B produces frame level outputs 114B containing feature embeddings that encode spatial relationships between the vehicle and its surrounding environment, including lane boundaries, other vehicles, and road geometry.

The frame level outputs 112B and 114B from both vision models are provided to temporal heads 116B and 118B. In this temporal model implementation, the temporal heads perform a different function compared to the state machine approach illustrated in FIG. 1A. Rather than implementing complex rule-based logic for behavioral pattern detection, the temporal heads in this architecture accumulate feature embeddings and manage the synchronization between different data streams to ensure temporally aligned processing.

The accumulated feature embeddings are organized into temporal sequences and provided to temporal neural networks that perform learned pattern recognition across time. These temporal models may employ various architectures including recurrent neural networks (RNNs), long short-term memory networks (LSTMs), gated recurrent units (GRUs), temporal convolutional networks (TCNs), or transformer-based attention mechanisms. The temporal models analyze how visual patterns evolve over multiple frames, enabling detection of behavioral progressions such as gradual eye closure, progressive head drooping, or increasing yawn frequency that unfold across several seconds.

The temporal neural network implementations can be categorized into two distinct architectural approaches, each with specific advantages for drowsiness detection. In a first implementation, the temporal network operates by accumulating feature embeddings across a sliding time window, concatenating or stacking the embeddings from consecutive frames to form an extended temporal representation. This accumulated representation is then processed through the neural network layers to identify behavioral patterns that emerge from the collective features across the time window. For example, a temporal convolutional network may apply convolutional filters across the temporal dimension of the accumulated embeddings to detect characteristic patterns in how facial features evolve during a yawning behavior or how head position changes during progressive drowsiness onset. This accumulation-based approach enables the network to capture short-to-medium term behavioral dynamics within the fixed window duration.

In a second implementation, the temporal network incorporates an explicit memory mechanism that maintains persistent context across multiple time windows, enabling the system to leverage long-term behavioral history when making predictions for the current time window. This memory-based architecture comprises two distinct components: a feature embedding module that processes the current time window to generate a representation of present visual patterns, and a memory buffer that stores encoded representations of previous temporal contexts. The memory buffer may be implemented through recurrent architectures such as LSTMs or GRUs, where the hidden state serves as a compressed representation of all previously observed behavior patterns. Alternatively, the memory may be implemented as an explicit external memory structure with attention-based retrieval mechanisms, as employed in memory-augmented neural networks. At each time step, the network combines the feature embeddings from the current time window with the retrieved or maintained memory context from previous windows. This combination enables the network to make predictions that account for both immediate visual patterns and longer-term behavioral trajectories. For instance, the system can detect that a current borderline yawning behavior should be classified as a drowsiness indicator because the memory context indicates the driver has exhibited increasing yawn frequency over the past several minutes, whereas the same visual pattern might be dismissed as insignificant if the memory context shows no prior drowsiness indicators. The memory-based approach provides superior capability for detecting gradual drowsiness onset that manifests through slowly evolving behavioral changes across extended durations that exceed practical sliding window sizes.

The telematics data 106B follows a parallel processing pathway through its own analysis pipeline similar to the temporal heads 116B and 118B. Time-series analysis of vehicle operational parameters identifies patterns indicative of degraded driver control, such as increasing steering corrections, speed instability, or delayed braking responses. The temporal correlation of these vehicular patterns with visual behavioral indicators provides robust multi-modal drowsiness detection.

The outputs from the temporal heads 116B and 118B as well as telematics data 106B are organized into three separate event record databases: driver-facing event records 120B, road-facing event records 122B, and telematics event records 124B. These databases maintain structured logs of detected atomic events with associated metadata including timestamps, confidence scores, event durations, and the feature patterns that triggered detection. The separation into distinct databases enables independent analysis and optimization of each detection modality while facilitating their subsequent integration.

Finally, event aggregator 138 receives the atomic events from all three record databases and performs comprehensive drowsiness assessment through multi-modal fusion. The event aggregator 138 analyzes temporal correlations between events from different modalities, recognizing that simultaneous or closely-sequenced events across multiple channels provide stronger evidence of drowsiness than isolated indicators. For example, the co-occurrence of yawning detected in driver-facing analysis with lane drift detected in road-facing analysis within a narrow time window would receive higher severity weighting than either event occurring independently.

The temporal model approach illustrated in FIG. 1B offers several advantages over purely rule-based implementations. The learned temporal representations can capture subtle behavioral patterns that may be difficult to encode in explicit rules. The architecture maintains flexibility to detect both gradual onset drowsiness characterized by slowly evolving behavioral changes and sudden fatigue episodes marked by abrupt alterations in driver state. The feature-level processing reduces the dependency on perfectly accurate frame-level classifications, as the temporal models can learn to be robust to occasional misdetections in individual frames by considering broader temporal context. This implementation approach provides a balance between the interpretability of modular architectures and the performance benefits of learned temporal pattern recognition.

FIG. 1C illustrates a detailed block diagram of the atomic event identifier 110 implemented using an end-to-end trainable model approach according to some of the disclosed embodiments. This implementation architecture represents a fully integrated neural network design that directly processes raw input data to generate drowsiness event classifications without intermediate feature extraction or separate temporal aggregation stages.

As illustrated, edge processor 108 receives the same three parallel input data streams utilized in the other implementation approaches. Driver-facing frames 102C provide continuous visual monitoring of driver behavior and cabin environment. Road-facing frames 104C capture the vehicle's surrounding environment and trajectory. Telematics data 106C supplies real-time measurements of vehicle operational parameters. The key distinction in this end-to-end architecture is how these inputs are processed through a unified computational pipeline rather than through separate modular components, as discussed below

As illustrated, driver-facing frames 102C are input to a first end-to-end model 120C while road-facing frames 104C are input to a second end-to-end model 122C.

The first end-to-end model 120C and second end-to-end model 122C each comprise integrated neural network architectures that directly process sequences of input frames to generate atomic event scores without requiring intermediate frame-level outputs or separate temporal decision stages. Unlike the modular approaches illustrated in FIGS. 1A and 1B where frame-level feature extraction and temporal aggregation occur as distinct processing steps, the end-to-end models perform spatiotemporal analysis as a unified operation, directly mapping from raw video input to behavioral event classifications.

In some implementations, the end-to-end models process temporal windows of consecutive frames as three-dimensional input tensors, where the temporal dimension is treated as an inherent component of the input representation alongside spatial dimensions. The neural network architecture applies learned transformations across all three dimensions simultaneously, enabling the model to capture motion patterns, behavioral evolution, and temporal dependencies directly from the raw pixel data. This integrated processing approach allows the network to learn optimal spatiotemporal feature representations specifically tuned for drowsiness behavior detection without being constrained by predetermined feature extraction strategies or handcrafted temporal aggregation rules.

The first end-to-end model 120C processes driver-facing frames 102C to directly generate driver-facing event records 124C containing atomic behavioral indicators such as yawning, eye closure, head drooping, or other fatigue-related behaviors detected within the input video sequence. Similarly, the second end-to-end model 122C processes road-facing frames 104C to directly generate road-facing event records 126C containing indicators such as lane drift, erratic trajectory, or abnormal vehicle positioning patterns. Each model outputs event scores representing the confidence and timing of detected behaviors, along with associated metadata such as behavior duration, severity indicators, and temporal localization within the processed video segment.

The end-to-end architecture eliminates the need for intermediate feature embeddings or frame-level classification outputs that characterize the modular approaches. Instead of first detecting that a driver's mouth is open in individual frames and then applying temporal logic to determine if this constitutes a yawn, the end-to-end model analyzes the entire temporal sequence holistically to directly assess whether a yawning behavior occurred. This direct approach can capture subtle temporal dynamics such as the characteristic opening and closing pattern of a yawn, the coordination between mouth opening and head tilt, or the timing relationships between multiple behavioral indicators that might be difficult to encode in explicit temporal rules.

In some implementations, the end-to-end models are trained using video sequences labeled with ground truth atomic event annotations, where the training objective optimizes the models to predict accurate event scores directly from input video. The training process jointly optimizes all network parameters—from initial spatiotemporal feature extraction through final event classification—using gradients backpropagated from the event prediction objectives. This joint optimization enables the network to learn feature representations at all levels that are specifically adapted to the drowsiness detection task, potentially discovering visual and temporal patterns that are more discriminative than features designed for general-purpose computer vision applications.

The telematics data 106C follows an integrated processing pathway alongside the visual data streams. While illustrated separately for clarity, the telematics processing in this end-to-end architecture is designed to be jointly optimized with visual processing pathways. The telematics analysis may employ temporal convolutional networks or recurrent architectures that process time-series vehicle sensor data to identify control quality degradation patterns. The learned representations from telematics processing are designed to be complementary to visual behavioral analysis, with the entire multi-modal network trained to leverage correlations between driver behaviors and vehicle control patterns.

The filtered outputs are organized into three event record databases: driver-facing event records 124C, road-facing event records 126C, and telematics event records 128C. These databases maintain the same structured event logging functionality as in other implementation approaches, ensuring compatibility with downstream processing components regardless of how the atomic events were generated.

Finally, event aggregator 138 performs multi-modal fusion of the detected atomic events to generate comprehensive drowsiness assessments. The event aggregator operates identically across all three implementation approaches, providing consistent downstream processing regardless of which atomic event detection architecture is deployed.

The end-to-end approach illustrated in FIG. 1C offers distinct advantages for drowsiness detection applications. The joint optimization of all processing stages enables the network to learn task-specific feature representations that may be more discriminative than generic computer vision features. The integrated spatiotemporal processing can capture complex behavioral dynamics that emerge over multiple seconds of video without requiring explicit temporal aggregation logic. The architecture can potentially achieve superior detection accuracy by optimizing feature extraction, temporal pattern recognition, and event classification simultaneously through a unified training objective. However, this approach typically requires more extensive training data and computational resources compared to modular implementations, and the learned representations may be less interpretable than explicitly designed feature extraction and state machine logic. The end-to-end architecture represents a fully learned approach that leverages modern deep learning capabilities to automatically discover optimal drowsiness detection strategies from data.

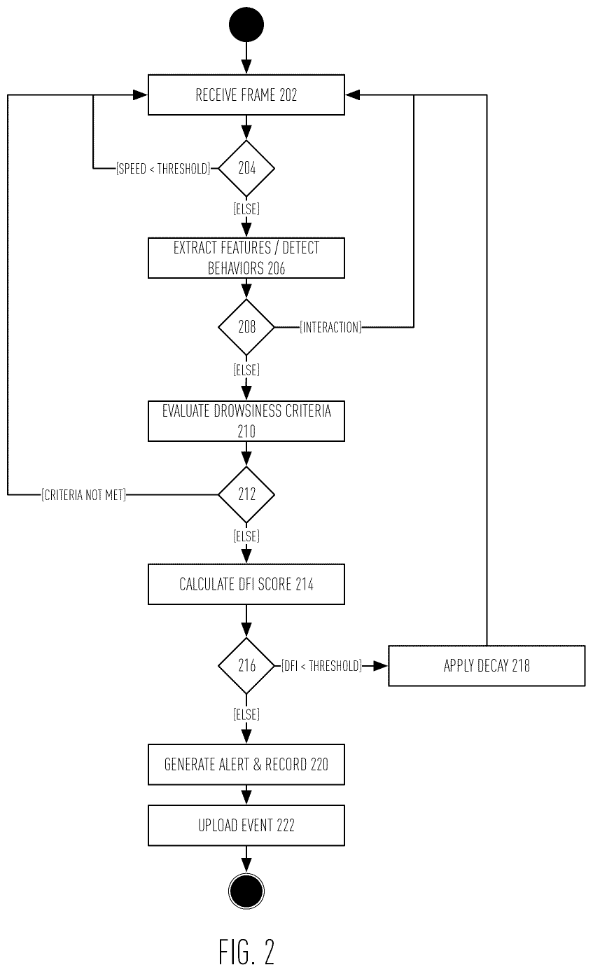

FIG. 2 is a flow diagram illustrating a method for detecting driver drowsiness using multi-modal behavioral analysis according to some of the disclosed embodiments.

In step 202, the method begins by receiving a frame from the vehicle's camera system. In some implementations, this frame is captured by a driver-facing camera positioned to view the entire cabin interior, including both the driver and passenger areas. The frame capture occurs continuously during vehicle operation, with the processing system analyzing each frame in real-time to detect potential drowsiness indicators. In some implementations, the frame rate may be configured between 15 to 30 frames per second, providing sufficient temporal resolution to capture transient behaviors such as yawning or brief eye closures while maintaining computational efficiency.

In step 204, the method evaluates whether the vehicle speed exceeds a set threshold (e.g., 40 kilometers per hour). This speed threshold serves as an activation gate for the drowsiness detection system. In some implementations, the rationale for this threshold is based on the observation that drowsiness-related accidents are more severe and more likely to occur at higher speeds, particularly on highways and arterial roads where monotonous driving conditions can exacerbate fatigue. When the vehicle speed is below this threshold, such as during parking maneuvers or stop-and-go traffic, the method returns to step 202 to receive the next frame without performing drowsiness analysis. This selective activation conserves computational resources and reduces false positive detections that might occur during low-speed operations where driver behaviors may not reliably indicate drowsiness.

When the speed threshold is met, the method proceeds to step 206, where features are extracted and multiple behavioral indicators are detected. In some implementations, feature extraction processes the raw image data through neural network architectures to generate representations suitable for behavioral analysis. The processing architecture may employ various approaches including unified models with task-specific detection heads, temporal neural networks operating on feature embeddings, or end-to-end models that directly classify behaviors from video sequences. These extracted representations encode information about facial landmarks, head pose, body position, and objects present in the cabin environment.

In step 206, the method detects three primary drowsiness indicators: yawning, head position, and eye state. The detection approach varies depending on system architecture but generates assessments of yawning behaviors including mouth opening patterns and sustained opening duration; head position and orientation relative to a baseline upright position; and eye state including whether the eyes are open, closed, or in an intermediate state, accounting for normal blinking patterns while identifying abnormally long closures that exceed typical blink durations. Additionally, step 206 maintains temporal tracking of these behaviors, including tracking yawning frequency and monitoring eye closure durations across consecutive frames or temporal windows.

In step 208, the method performs an object interaction check to disambiguate detected behaviors. In some implementations, when head drooping is detected, the system analyzes the frame to identify common cabin objects such as mobile phones, food items, beverages, or paperwork. This object interaction check addresses a key challenge in drowsiness detection: distinguishing between fatigue-related behaviors and normal cabin activities that may produce similar visual patterns. If object interaction is detected, indicating the driver is engaged in purposeful activity, the method returns to step 202 to continue monitoring without flagging a drowsiness indicator. If no object interaction is detected while behaviors like head drooping are present, the method proceeds to evaluate drowsiness criteria, as head drooping without apparent purpose represents a strong indicator of fatigue.

In step 210, the method evaluates multiple drowsiness criteria based on the detected behaviors and their temporal patterns. In some non-limiting implementations, the evaluation implements three pathways for triggering drowsiness events. First, the method checks whether two yawning events have occurred within a three-minute window, due to excessive yawning frequency being correlated with fatigue states. Second, the method evaluates whether a yawning event and any of the atomic events (such as head drooping without object interaction) have occurred within a one-minute window, recognizing that co-occurrence of multiple indicators provides strong evidence of fatigue. Third, the method checks whether eye closure duration exceeds 2.5 seconds, significantly longer than normal blink durations of 100-400 milliseconds, indicating potential microsleep episodes. This multi-criteria approach provides sensitivity to both gradual onset drowsiness and sudden fatigue episodes. The specific numeric values and ranges are not intended to be limiting.

In step 212, if any drowsiness criteria are met, the method proceeds to calculate a Driver Fatigue Index (DFI) score in step 214. If no criteria are met, the method returns to step 202 to continue monitoring. This decision point ensures that only validated drowsiness indicators contribute to fatigue assessment, maintaining system specificity while avoiding alert fatigue from marginal detections.

In step 214, the method calculates the DFI score by aggregating the various detected events and applying configurable weights based on the severity and reliability of each indicator type. In some implementations, microsleep events may receive higher weights than isolated yawning events, reflecting their greater correlation with accident risk. The DFI score provides a continuous measure of drowsiness risk that accounts for both the types and patterns of detected behaviors, enabling nuanced assessment beyond binary drowsy/alert classifications.

In some implementations, the system employs a multi-tier validation architecture wherein the edge processor performs initial drowsiness event detection and the cloud system applies secondary validation to refine event accuracy and severity assessment. When the edge processor generates a drowsiness or fatigue event, it transmits the associated video evidence along with comprehensive metadata to a cloud processing system. This metadata includes the specific atomic behavioral indicators that contributed to the DFI score exceeding the threshold, timestamps for each detected behavior, confidence scores from the atomic event identifier, vehicle operational parameters during the event window, and the calculated DFI score that triggered the event generation.

Upon receiving the event data, the cloud processing system applies advanced filtering algorithms to validate each atomic behavioral indicator. These advanced filters may employ more computationally intensive machine learning models that are impractical for edge deployment, leverage larger temporal context windows that span multiple minutes of driving behavior, incorporate fleet-wide behavioral baselines to identify truly anomalous patterns, or apply sophisticated scene understanding to eliminate false positives caused by environmental factors. When one or more atomic behaviors fail to pass the advanced cloud filters, the cloud system recalculates the DFI score using only the validated behavioral indicators. If this recalculated DFI score falls below the original detection threshold, the cloud system queries a behavior cache to retrieve additional atomic events that occurred within the same temporal window but did not contribute to the original edge-based DFI calculation. The system then evaluates whether alternative combinations of validated behaviors and cached events can substantiate a legitimate drowsiness event, effectively allowing behavior substitution to maintain event validity even when some initially detected behaviors are rejected by advanced filtering.

In an alternative implementation, the edge processor continuously transmits detected atomic behavioral indicators to the cloud system as they occur, independent of whether they trigger a drowsiness event. The cloud system maintains a temporal cache of these atomic behaviors organized by vehicle, driver, and timestamp. When the edge processor subsequently generates a fatigue or drowsiness event, the cloud system computes an independent DFI score by retrieving all relevant atomic behaviors from the cache that fall within the event's temporal context window. This cloud-based DFI calculation may apply different weighting factors, incorporate additional contextual information unavailable at the edge, or utilize more sophisticated aggregation models. The dual-calculation approach enables the system to validate edge-generated events through independent analysis and provides resilience against edge processing errors or network-induced gaps in behavior transmission.

Following cloud-based validation and DFI recalculation, events that fall into an ambiguous confidence range or exhibit characteristics warranting expert review are forwarded to human validators. The human review interface presents the video evidence along with visualizations of all atomic behavioral indicators associated with the drowsiness event, including both those that contributed to the original DFI calculation and those retrieved from the behavior cache. Human reviewers assess the validity of each atomic event, potentially rejecting behaviors that were incorrectly classified by the automated detection system or confirming behaviors that were flagged as uncertain. Upon completion of human review, the system performs a final DFI score recalculation incorporating only the human-validated behavioral indicators. This human-validated DFI score is then mapped to a severity classification—low, medium, or high—based on configurable threshold ranges. For example, scores between the detection threshold and a first elevated threshold may be classified as low severity events warranting driver notification, scores between the first and second elevated thresholds may represent medium severity events requiring fleet manager review, and scores exceeding the second elevated threshold may constitute high severity events demanding immediate intervention. The severity classifications and their associated thresholds can be customized per fleet based on operational requirements, risk tolerance, and regulatory obligations. The human validation outcomes and refined severity assessments are subsequently used to update the edge processor's detection parameters, creating a continuous improvement feedback loop that enhances system accuracy over time.

In step 216, the method compares the calculated DFI score against a configurable threshold. This threshold may be adjusted based on factors such as the specific vehicle application, regulatory requirements, or fleet safety policies. If the DFI score exceeds the threshold, indicating significant drowsiness risk, the method proceeds to generate alerts and capture evidence. If the score remains below the threshold, the method proceeds to step 218 where decay functions are applied.

In step 218, the method applies decay functions to gradually reduce the influence of past events on the current drowsiness assessment. In some implementations, the decay may be linear or exponential, with different rates for different behavior types. This temporal decay ensures that isolated events don't permanently elevate the DFI score while maintaining appropriate memory of recent indicators. After applying decay, the method returns to step 202 to continue the monitoring cycle.

When the DFI threshold is exceeded, the method, in step 220, generates an in-cab alert and initiates video recording. In some implementations, alerts may include audio warnings, visual indicators, or haptic feedback designed to increase driver alertness without causing dangerous startle responses. Simultaneously, the system records video evidence of the drowsiness event, typically capturing several seconds of footage before and after the triggering event to provide context for later review.

In step 222, the method uploads the recorded event data to cloud systems for fleet manager review and long-term analytics. In some implementations, the upload includes the video evidence, detected behavior metadata, calculated DFI scores, and contextual information such as time of day, driving duration, and vehicle location. This comprehensive data supports both immediate safety interventions and continuous system improvement through aggregated analysis.

The flow structure illustrated in FIG. 2 maintains the sophisticated multi-modal behavioral analysis while presenting a clear, implementable drowsiness detection method. The behavioral detection, object interaction filtering, and multi-criteria evaluation work together to provide robust drowsiness detection that adapts to real-world driving scenarios while minimizing false positives from normal cabin activities.

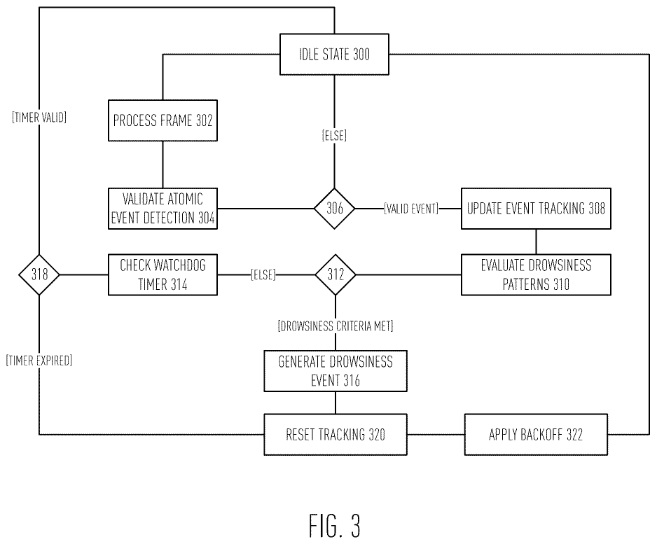

FIG. 3 is a flow diagram illustrating a state machine operation flow for drowsiness detection according to some of the disclosed embodiments.

The method begins at an idle state 300, representing the default condition where the state machine awaits incoming data. From this idle state, the system transitions to step 302 where a frame is processed. In some implementations, this frame processing occurs at regular intervals corresponding to the camera frame rate, ensuring continuous monitoring of driver behavior. The state machine architecture provides temporal context and memory across multiple frames, enabling the detection of behavioral patterns that unfold over time rather than relying solely on instantaneous frame analysis.

In step 304, the system validates whether a genuine atomic event has been detected in the processed frame. In some implementations, this validation implements multiple checks to ensure detection reliability. First, the system evaluates whether the atomic event confidence score exceeds 0.8, a threshold generated by a specialized neural network head trained to recognize characteristic atomic event patterns including mouth aperture, facial muscle movements, and temporal dynamics. Second, the system performs a tolerance check to ensure the detected atomic event behavior maintains consistency across consecutive frames within acceptable bounds, addressing natural variations in detection confidence due to lighting changes or partial occlusions. Third, the system tracks event duration, requiring that the atomic event behavior persist for at least three seconds to distinguish genuine atomic events from other mouth movements. This three-second threshold is based on physiological studies indicating that genuine atomic events typically last between 4-7 seconds. Finally, a voting filter ensures that a sufficient percentage of frames within the detection window contain high-confidence atomic event indicators, providing robustness against isolated false positives.

In step 306, the system determines whether all validation criteria have been met to confirm a valid atomic event. If any validation check fails—whether due to insufficient confidence, inconsistent detection, inadequate duration, or insufficient frame voting—the system returns to the idle state 300, effectively filtering out ambiguous or incomplete detections. Only when all criteria are satisfied does the system proceed with event processing, ensuring high precision in atomic event detection.

When a valid atomic event is confirmed, in step 308, the system updates the event tracking mechanisms that monitor behavioral patterns over time. In some implementations, this update process performs several operations. The system generates an atomic event record that includes metadata such as timestamp, duration, average confidence score, and potentially a video clip for later review. An atomic event counter is incremented to track the frequency of atomic events within specified time windows. The system also logs the event timing for temporal correlation analysis with other behavioral indicators. Additionally, a watchdog timer is updated to maintain a sliding window of recent events, typically spanning three minutes for atomic event frequency analysis. These tracking mechanisms enable the detection of behavioral patterns that emerge over minutes rather than seconds.

In step 310, the system evaluates multiple drowsiness patterns based on the accumulated behavioral data. In some implementations, this evaluation implements sophisticated temporal correlation logic across three primary detection pathways. First, the system checks for excessive atomic events by determining whether two or more atomic events have occurred within a three-minute window, based on research indicating that increased atomic event frequency correlates with fatigue states. Second, the system evaluates behavioral combinations by checking whether an atomic event and a distraction event have occurred within a one-minute window, recognizing that co-occurring indicators provide stronger evidence of drowsiness. Third, the system checks for critical events such as detected sleep episodes, where eye closure exceeds microsleep thresholds. The evaluation logic can detect these patterns regardless of the order in which behaviors occur, implementing bidirectional temporal correlation.

In step 312, the system determines whether any drowsiness criteria have been met based on the pattern evaluation. In some implementations, this decision point aggregates results from all detection pathways, proceeding to generate a drowsiness event if any criterion is satisfied. The multi-pathway approach ensures sensitivity to different manifestations of drowsiness, from gradual onset indicated by increasing atomic event frequency to sudden episodes marked by microsleep events. If no criteria are met, the system proceeds to watchdog timer management to maintain appropriate temporal bounds on pattern detection.

When no immediate drowsiness criteria are satisfied, in step 314, the system checks the watchdog timer status. In some implementations, the watchdog timer serves multiple purposes: preventing indefinite accumulation of old events, maintaining temporal relevance in pattern detection, and ensuring that correlation windows (such as the three-minute window for multiple atomic events) eventually close. The timer check evaluates whether the maximum correlation period has elapsed without meeting drowsiness criteria, determining whether to continue monitoring or reset tracking state.

In step 318, the system evaluates whether the watchdog timer has expired. In some implementations, timer expiration occurs when the configured correlation window has fully elapsed without detecting drowsiness patterns. For example, if more than three minutes have passed since the first atomic event without detecting a second atomic event or correlated behavior, the timer expires to prevent that initial event from indefinitely influencing future correlations. If the timer has not expired, the system returns to the idle state 300 to await the next frame while maintaining current tracking state.

When drowsiness criteria are met, in step 316 the system generates a drowsiness event that triggers appropriate system responses. In some implementations, the drowsiness event includes comprehensive information about the contributing behavioral patterns, their temporal relationships, confidence scores, and severity assessment. The event generation may trigger immediate safety responses such as in-cab driver alerts, video evidence recording, and notifications to fleet management systems. The hierarchical nature of the state machine ensures that drowsiness events represent validated patterns rather than isolated behavioral anomalies.

Following either drowsiness event generation or watchdog timer expiration, in step 320 the system resets the tracking mechanisms to prepare for detecting new patterns. In some implementations, this reset clears atomic event counters, event timestamps, and correlation windows while preserving generated event records for historical analysis. The reset ensures that previous behavioral patterns don't inappropriately influence future detections while maintaining the ability to detect recurring drowsiness episodes.

In step 322, the system applies a backoff period following drowsiness event generation. In some implementations, this backoff period typically lasts 60 seconds or another configured duration, during which new drowsiness events are suppressed even if behavioral criteria are met. The backoff mechanism serves several purposes: allowing time for driver alerts to take effect, preventing alert fatigue from rapid repeated triggers, and enabling the driver to demonstrate recovered alertness. After the backoff period expires, the system returns to the idle state 300 to resume normal monitoring.

The state machine architecture illustrated in FIG. 3 maintains sophisticated temporal pattern detection while presenting a clear, implementable flow. The comprehensive validation in step 304 ensures high-quality behavioral detection, while the pattern evaluation in step 310 captures complex drowsiness manifestations. The watchdog timer and backoff mechanisms provide appropriate temporal bounds that balance detection sensitivity with system stability, enabling practical deployment in real-world driving scenarios.

In some implementations, the system employs telematics-based speed variation analysis as a complementary indicator of driver fatigue that operates independently of visual behavioral detection. This approach recognizes that drowsy or fatigued drivers often exhibit characteristic changes in vehicle control that manifest as anomalous speed patterns, even before visual signs of drowsiness become apparent. The telematics processing module continuously monitors longitudinal vehicle speed data collected from the vehicle's onboard sensors, typically sampled at intervals ranging from 1 to 100 Hz/fps depending on system configuration and data transmission capabilities.

The one or more state machines configured for telematics analysis receive time-series vehicle speed data organized into a plurality of consecutive time intervals. In some implementations, these intervals may span 30-second to 5-minute windows, providing sufficient temporal context to identify meaningful patterns while maintaining responsiveness to emerging fatigue indicators. The state machines maintain a rolling buffer of recent speed measurements along with associated contextual information such as road type, traffic conditions, and weather data when available.

The analysis algorithms identify several distinct speed variation patterns that correlate with driver fatigue. Inconsistent acceleration patterns are detected when the driver applies throttle input with unusual variability, such as alternating between gentle and aggressive acceleration during highway driving where smooth, consistent acceleration would be expected. The system calculates metrics such as acceleration variance, the frequency of acceleration reversals, and deviations from typical acceleration profiles for the current road conditions. Erratic deceleration patterns are identified through analysis of braking events and throttle release behaviors. Fatigued drivers may exhibit delayed brake responses followed by harder-than-necessary braking, or may demonstrate inconsistent deceleration rates when approaching anticipated slow-downs such as highway exit ramps or traffic signals. The system monitors deceleration event timing, magnitude, and smoothness compared to baseline patterns established for the specific driver and vehicle type.

Failure to maintain consistent cruising speed represents a particularly strong indicator of fatigue during highway driving. Alert drivers typically maintain steady speeds during cruise conditions, with variations primarily driven by traffic conditions or intentional speed adjustments. Fatigued drivers, conversely, often exhibit “speed creep” patterns where vehicle speed gradually drifts upward or downward over extended periods, or display oscillating speed patterns where the vehicle repeatedly accelerates and decelerates within a narrow speed range without apparent traffic-related cause. The system calculates speed variance metrics over sliding temporal windows, comparing observed variance against expected variance for the current road type and traffic density. Significant deviations from expected variance thresholds trigger fatigue indicator flags.

The state machines generate a speed-based fatigue metric by aggregating evidence from the identified speed variation patterns. In some implementations, this metric is calculated as a weighted combination of individual pattern indicators, where weights are determined through empirical analysis of how strongly each pattern type correlates with confirmed fatigue events. For example, inconsistent acceleration during nighttime highway driving may receive higher weighting than during daytime urban driving due to stronger correlation with drowsiness in the former context. The speed-based fatigue metric is normalized to a standardized scale, such as 0 to 100, enabling consistent integration with other fatigue indicators.

The edge processor incorporates the speed-based fatigue metric as an additional input to the DFI score calculation, using it to corroborate and refine assessments derived from visual behavioral analysis. In some implementations, the telematics-based metric serves multiple functions within the DFI calculation framework. First, it provides independent confirmation of fatigue when visual indicators are also present, increasing confidence in drowsiness event generation. For example, when both yawning behaviors and speed inconsistency are detected simultaneously, the combined evidence justifies higher DFI scores than either indicator alone would produce. Second, the speed-based metric can serve as an early warning indicator that increases system sensitivity to subsequent visual behaviors. When abnormal speed patterns are detected, the system may lower detection thresholds for visual indicators, recognizing that the driver may be entering a fatigued state. Third, the telematics data provides resilience against visual detection limitations. In conditions where visual analysis may be degraded—such as drivers wearing face coverings, extreme lighting conditions, or camera obstruction—the speed-based fatigue metric continues to provide meaningful drowsiness assessment.

The integration of speed-based metrics with visual behavioral indicators is performed through configurable fusion rules within the DFI calculation. In some implementations, the fusion employs weighted averaging where the telematics contribution to the overall DFI score is modulated based on driving context. Highway driving scenarios, where speed patterns are most informative, may allocate 20-30% of the DFI score weight to telematics inputs, while urban driving with frequent speed changes due to traffic conditions may reduce this weighting to 5-10%. Alternative implementations employ probabilistic fusion approaches where the speed-based metric adjusts the prior probability of drowsiness before visual behavioral evidence is considered, effectively tuning the system's baseline sensitivity.

The state machines maintain adaptive baseline models that account for individual driver characteristics and vehicle operational patterns. Different drivers may exhibit distinct “normal” speed control behaviors based on factors such as driving experience, vehicle familiarity, and personal driving style. The system establishes personalized baselines through observation of each driver's speed control patterns during periods confirmed to be alert, such as the first 30 minutes after shift start. Detected speed variations are then evaluated relative to these personalized baselines rather than generic population averages, improving detection specificity by reducing false positives from drivers whose natural driving style might otherwise be misinterpreted as fatigue indicators.

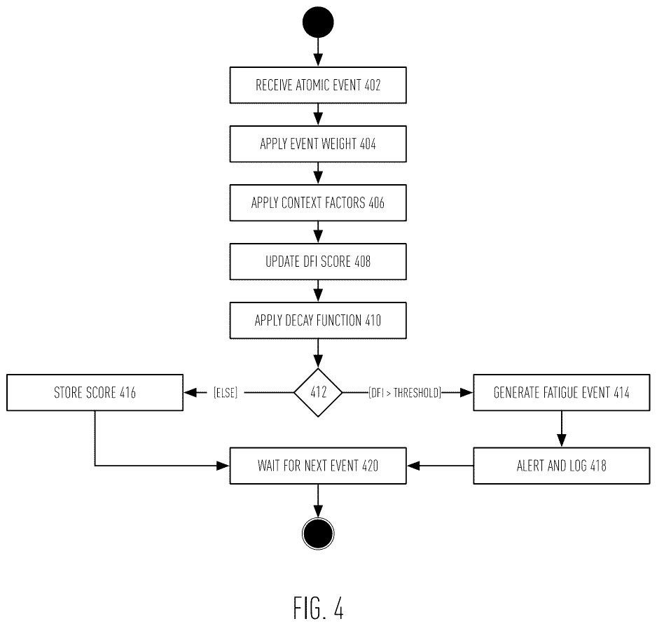

FIG. 4 is a flow diagram illustrating a method for calculating a Driver Fatigue Index (DFI) according to some of the disclosed embodiments.

In step 402, the system receives an atomic event from the drowsiness detection pipeline. In some implementations, atomic events represent discrete behavioral or vehicular indicators that have been detected and validated by upstream processing components such as the state machines described in FIG. 3. These atomic events serve as the fundamental inputs to the DFI calculation system, providing standardized representations of drowsiness-related behaviors that can be quantitatively analyzed and aggregated. Each atomic event typically includes metadata such as event type, timestamp, confidence score, duration, and any relevant contextual information captured during detection.

In step 404, the method applies behavior-specific weights to the received atomic event based on its type. In some implementations, the system first classifies the atomic event type—whether yawning, microsleep, lane swerve, head droop, or eye closure—then applies corresponding weight values that represent scaling factors adjusting each behavior's contribution to the overall fatigue assessment. These weights are derived through empirical analysis of drowsiness incidents, with behaviors showing stronger statistical correlation with fatigue-related accidents receiving higher weights. For example, microsleep events receive high weights reflecting their severe danger, with the weight potentially scaled by episode duration. Lane swerving weights consider the magnitude of deviation and correction frequency. Head drooping weights account for severity and whether object interaction was detected. Atomic event weights may be moderate, recognizing that while common in drowsiness, atomic events can occur in non-fatigue contexts. Eye closure weights scale with duration, distinguishing between heavy-lidded blinking and complete closures. The weighted event value is then added to the cumulative DFI score, maintaining a running total of drowsiness evidence across multiple behavioral indicators.

In step 406, the method applies contextual factors that modulate the DFI score based on driving conditions and history. In some implementations, this step performs three primary contextual adjustments. First, the system retrieves and applies historical context including the duration of the current driving session, hours driven in the past 24 hours, previous drowsiness events, and long-term driver patterns. A context multiplier increases when factors suggest elevated fatigue risk, such as continuous driving exceeding two hours or multiple previous drowsiness events. Second, the system checks the current time of day and applies circadian rhythm adjustments. Nighttime driving, particularly during early morning hours (2 AM to 5 AM) when alertness naturally reaches its nadir, triggers application of a night factor that increases detection sensitivity. The system may adjust these factors based on driver-specific patterns, such as regular night shift work. Third, the system may incorporate additional environmental factors such as weather conditions or road type that influence fatigue development. These contextual adjustments ensure that identical behaviors receive appropriate weight based on when and under what conditions they occur.

In step 408, the method updates the total DFI score by incorporating all weights and contextual factors (e.g., time of day, hours driven, etc.). In some implementations, this update involves sophisticated aggregation beyond simple addition, potentially including non-linear combinations or interaction terms between different event types. The total DFI score is maintained as a continuous value ranging from zero (no drowsiness indicators) to a maximum determined by simultaneous severe indicators. The score represents an instantaneous assessment of drowsiness risk that accounts for both the immediate behavioral indicator and the accumulated context of the driving session.

In step 410, the method applies a decay function to implement temporal relevance in the drowsiness assessment. In some implementations, the system supports multiple decay strategies to model how the influence of past events diminishes over time. Linear decay reduces the DFI score by a constant amount per unit time, providing predictable, uniform reduction where older events lose relevance at a steady rate. Exponential decay causes score influence to decrease rapidly initially then level off, better modeling physiological recovery from brief drowsiness episodes where alertness can return quickly but residual fatigue effects linger. The decay parameters may be configured differently for different event types, recognizing that some behaviors have longer-lasting influence than others. For instance, a microsleep event might decay more slowly than an isolated atomic event (such as stretching or touching face), reflecting its greater significance for ongoing drowsiness risk. The decay mechanism ensures that behavioral indicators from many minutes ago have diminished influence while maintaining appropriate memory of recent events. In some implementations, the method may also use an ML-based decay calculation based on a configuration parameter.

In step 412, the method compares the decayed DFI score against a configurable threshold. In some implementations, this threshold determines when accumulated drowsiness evidence warrants safety intervention. The threshold may be adjusted based on factors such as vehicle application (long-haul trucking versus urban delivery), regulatory requirements, fleet safety policies, or individual driver history. The comparison produces a binary decision that balances sensitivity to genuine drowsiness against false positive minimization.

When the DFI score exceeds the threshold, in step 414, the method generates a fatigue event that triggers safety responses. In some implementations, the fatigue event includes comprehensive information about contributing behavioral patterns, their temporal relationships, confidence scores, and severity assessment. The event generation initiates cascading safety responses appropriate to the detected risk level, ensuring timely intervention when drowsiness threatens safe vehicle operation.

In step 418, the method implements alert generation and event logging for the triggered fatigue event. In some implementations, alerts encompass multiple modalities selected based on severity and driver preferences. In-cab audio warnings may range from gentle chimes for mild drowsiness to urgent alarms for severe fatigue. Visual indicators on dashboard displays provide persistent reminders. Haptic feedback through seats or steering wheels offers non-auditory alerting. The alert intensity and combination adapt to the degree of DFI threshold exceedance. Simultaneously, the system logs comprehensive event data including all contributing atomic events, their temporal sequence, calculated weights and factors, historical context, and the final DFI score. Video clips spanning several seconds before and after the triggering event are captured and associated with the log entry. This rich data supports fleet manager review, driver coaching, regulatory compliance, and continuous system improvement through pattern analysis across multiple events.

When the DFI score remains below threshold at step 412, step 416 stores the current score for historical tracking. In some implementations, this storage maintains the temporal evolution of DFI scores throughout the driving session, enabling post-trip analysis of fatigue development patterns. The stored scores support future decay calculations and provide context for interpreting subsequent behavioral indicators.

In step 420, the method implements a waiting period for the next atomic event. In some implementations, the system maintains the current DFI state including all accumulated scores, active decay processes, and contextual factors while monitoring for new behavioral indicators. This continuous readiness ensures rapid response to emerging drowsiness patterns while avoiding unnecessary computation during periods without detected behaviors.

The DFI calculation method illustrated in FIG. 4 provides sophisticated multi-factor drowsiness assessment within a streamlined processing flow. The consolidated weight application captures behavior-specific risk levels, while unified contextual adjustment accounts for environmental and historical factors. The decay mechanism maintains temporal relevance, and threshold-based triggering ensures appropriate safety responses. This architecture enables nuanced drowsiness detection that adapts to varying contexts while remaining computationally efficient for real-time edge processing.

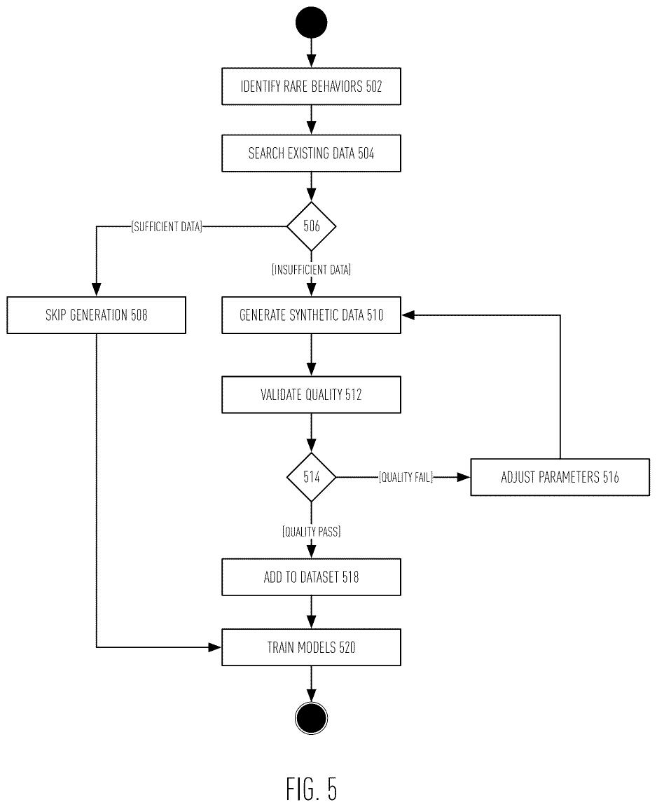

FIG. 5 is a flow diagram illustrating a method for generating synthetic training data for drowsiness detection according to some of the disclosed embodiments.

In step 502, the method begins by identifying rare behaviors that require additional training data. In some implementations, rare behaviors comprise drowsiness-related actions that occur infrequently in real-world driving scenarios but are critical for comprehensive model training. These may include specific types of atomic event patterns (such as yawning while covering the mouth), particular head nodding sequences, eye rubbing gestures, stretching movements, or combinations of behaviors that indicate severe fatigue. The identification process may analyze existing training data distributions to determine which behavioral categories have insufficient representation, typically falling below threshold percentages required for robust model generalization. For example, while open-mouth yawning may be well-represented in collected data, instances of drivers rubbing their eyes or performing specific stretching movements may constitute less than 1% of the training samples, necessitating synthetic augmentation.

In step 504, the method searches existing data repositories for examples of the identified rare behaviors. In some implementations, this search employs Vision Language Models (VLMs) such as CLIP (Contrastive Language-Image Pre-training), BLIP (Bootstrapping Language-Image Pre-training), LLAVA (Large Language and Vision Assistant), or PaliGemma to process natural language queries against millions of archived frames. The queries are formulated as descriptive text phrases capturing the visual characteristics of target behaviors, such as “driver rubbing eyes with both hands” or “person yawning while driving at night.” The VLMs encode these textual descriptions into feature representations that can be matched against visual features extracted from video frames, enabling efficient semantic search across massive datasets without requiring manual annotation. The search results are then filtered to retain only the most relevant frames based on confidence scores, visual quality metrics, and contextual appropriateness. The filtering verifies that detected behaviors occur within proper vehicular contexts, with subjects positioned in driver's seats and exhibiting behaviors from appropriate camera angles. The process ensures diversity in retained frames across demographics, lighting conditions, vehicle types, and camera perspectives.

In step 506, the method evaluates whether sufficient real-world data has been obtained through the search process. In some implementations, sufficiency is determined by comparing the number of high-quality examples against minimum thresholds established for effective model training. These thresholds vary by behavior type, with simple behaviors like basic yawning requiring a few thousand examples while complex multi-step behaviors like specific stretching sequences might require significantly more-examples to capture their full variability. The evaluation also considers diversity across relevant dimensions such as subject appearance, environmental conditions, and behavioral variations.

When sufficient data is available, in step 508, the method skips the generation phase, recognizing that synthetic data should supplement rather than replace real-world data when adequate examples exist. This path conserves computational resources and avoids potential artifacts or biases that synthetic data might introduce.

When insufficient data is available, in step 510, the method generates synthetic data using one of three generation approaches selected based on the behavior characteristics and available seed data. In some implementations, the generation process adapts its approach to the specific requirements of each behavior type:

For image-to-video generation, the system loads a reference image showing a subject in a neutral state, then applies detailed text prompts specifying the desired behavioral sequence. For example, a prompt might specify “driver gradually becomes drowsy, yawns slowly over 4 seconds while slightly tilting head back, then returns to normal position.” The generation employs diffusion-based models such as CogVideoX or Wan that maintain temporal consistency while introducing controlled motion, synthesizing intermediate frames that smoothly transition through the specified behavior. The process generates videos at standard frame rates with durations typically ranging from 2-10 seconds.

For video-to-video generation, the system transforms existing video sequences to introduce or modify drowsiness-related behaviors while preserving temporal coherence and realistic motion dynamics. This approach leverages generative adversarial networks (GANs) or diffusion models trained specifically for temporally consistent video transformation. The system can take source footage of drivers in alert states and apply learned transformations to synthesize progressive drowsiness behaviors such as gradual eye closure patterns, incremental head nodding movements, or postural slumping that develops across multiple seconds. The video-to-video approach maintains photorealistic appearance, natural lighting variations, and realistic motion blur while introducing behavioral indicators that may be underrepresented in naturally collected datasets. This technique is particularly valuable for generating examples of gradual drowsiness onset, where the model synthesizes smooth temporal transitions from fully alert to increasingly fatigued states across extended video sequences spanning 10-30 seconds or longer.

For Region of Interest (RoI) editing, the system defines bounding boxes encompassing relevant anatomical features for the target behavior. For yawning generation, the RoI encompasses the mouth and lower face region. Text descriptions specify desired modifications within the RoI, such as “open mouth showing teeth and tongue, stretched facial muscles, typical yawning expression.” Inpainting diffusion models generate photorealistic modifications within specified regions while maintaining consistency with surrounding image content, preserving lighting, skin tone, and facial structure while introducing the desired behavioral expression.

For pose sequence generation, the system extracts keypoint data from reference videos showing target behaviors, creating sequences of coordinate positions that capture movement dynamics independent of appearance. These sequences may be augmented with timing, amplitude, or pattern variations to increase diversity. Pose-conditioned diffusion models then animate reference images according to the pose trajectories, maintaining subject appearance and environmental context while introducing precise behavioral movements.

For style transfer applications, the system adapts existing drowsiness behavior examples across different environmental conditions, lighting scenarios, and camera perspectives. Style transfer neural networks enable transformation of behavioral footage captured in one visual context to appear as if recorded in a different context while preserving the essential behavioral characteristics. For example, well-lit daytime cabin footage showing yawning behaviors can be style-transferred to simulate nighttime interior illumination, creating training examples for challenging low-light detection scenarios without requiring actual nighttime data collection. Similarly, behaviors captured with one camera system's color characteristics and resolution can be adapted to match the visual properties of different deployed dashcam models. The style transfer approach addresses the challenge of achieving robust detection performance across diverse deployment environments without exhaustive data collection in every possible combination of lighting, weather, and equipment configuration.

For pose transfer applications, the system transfers detected drowsiness behavior patterns from source examples onto different driver representations, enabling creation of diverse training samples that maintain behavioral fidelity while varying physical characteristics. The pose transfer process begins by extracting skeletal pose and motion trajectories from source behavioral examples using human pose estimation networks. These extracted pose sequences capture the kinematic patterns of drowsiness behaviors—the angles, velocities, and temporal evolution of head position, torso posture, and limb movements—as numerical representations independent of the source subject's appearance. The system then applies these pose sequences to target driver images or videos, effectively synthesizing new examples where different individuals exhibit the same drowsiness behavior patterns. This approach enables generation of training data spanning diverse driver demographics, body types, seating positions, and anthropometric characteristics without requiring each demographic group to provide extensive behavioral examples. The pose transfer technique is particularly valuable for addressing dataset imbalances and ensuring equitable detection performance across diverse driver populations.

In addition to the synthetic generation techniques described above, some implementations incorporate data crowdsourcing methodologies that engage real human participants to perform and record drowsiness-related behaviors under controlled conditions. The crowdsourcing system recruits hundreds of human actors through dedicated data collection platforms, providing each participant with detailed behavioral specifications and performance guidance. These specifications describe the target drowsiness indicators with precise timing, amplitude, and quality requirements. For example, yawning instructions might specify mouth opening duration of 3-6 seconds, visible stretching of facial muscles, and natural head tilt patterns, along with examples of correct and incorrect execution. Head drooping specifications define angular ranges, rates of motion, and duration parameters that characterize genuine fatigue-related head movements. Eye closure instructions differentiate between normal blinking patterns and the sustained closures or heavy-lidded appearances associated with drowsiness.

Participants perform these specified behaviors while being recorded by camera systems configured to replicate deployed dashcam characteristics. The recording environment controls for consistent lighting, uses cameras with similar resolution and field-of-view to actual vehicle installations, and positions subjects in automotive seating arrangements that match real driving contexts. Each recording session captures multiple variations of each behavioral pattern, with participants instructed to vary timing, intensity, and naturalness to create diverse examples rather than mechanical repetitions. The controlled recording environment ensures comprehensive metadata annotation, with ground truth labels indicating precise start and end times for each behavior, confidence assessments of behavior quality, and contextual information about lighting conditions and subject positioning.

The crowdsourced approach offers several distinct advantages for training data development. The controlled nature enables systematic collection of behavioral examples that occur infrequently during natural driving, such as extreme fatigue states, specific behavior combinations, or transitional patterns between alert and drowsy states. The ability to provide explicit instructions ensures behaviors are performed with characteristics matching their real-world manifestations, avoiding the ambiguity that can arise when attempting to synthesize behaviors through purely computational methods. The crowdsourcing methodology also enables deliberate balancing of training data across demographic factors including age ranges, gender, ethnicity, facial features, and the presence of eyeglasses, facial hair, or head coverings. This systematic demographic balancing addresses potential algorithmic bias concerns by ensuring the detection models are trained on representative samples from diverse driver populations, thereby promoting equitable detection performance regardless of driver characteristics. The human-acted behavioral data provides high-quality ground truth examples with known labels and precise timing, facilitating supervised training of detection models and enabling rigorous performance evaluation across specific behavioral categories and demographic groups.

In step 512, the method validates the quality of generated synthetic data. In some implementations, validation employs multiple assessment criteria including visual quality metrics, behavioral accuracy verification, and artifact detection. Automated validation uses pre-trained models to verify that generated behaviors match their intended categories and appear natural within driving contexts. The validation checks for common generation artifacts such as temporal flickering, anatomically impossible positions, or inconsistent lighting. Each generated sample must meet minimum standards for visual realism, behavioral accuracy, and temporal consistency.

In step 514, the method determines whether the generated data passes quality criteria. In some implementations, this decision applies threshold requirements across multiple quality dimensions, with any critical failure resulting in rejection to prevent misleading training examples from degrading model performance.

When quality checks fail, in step 516, the method adjusts generation parameters based on specific validation failures. In some implementations, adjustments may include modifying prompt formulations, changing diffusion model sampling parameters, adjusting RoI boundaries, or selecting different reference images. The adjustment strategy targets identified issues, such as increasing temporal smoothness for flickering artifacts or modifying pose constraints for anatomically impossible positions. This iterative refinement continues until satisfactory quality is achieved or a maximum iteration limit is reached.

When quality checks pass, in step 518, the method adds the validated synthetic data to the training dataset. In some implementations, synthetic data is tagged with metadata identifying its generated nature, the generation method used, and source references. This tagging enables downstream training processes to apply appropriate weighting or sampling strategies that balance synthetic and real data contributions. The addition process maintains careful versioning and ensures appropriate distribution balancing across behavioral categories.

In step 520, the method trains or retrains drowsiness detection models using the augmented dataset. In some implementations, the training process leverages both real and synthetic data, with the synthetic examples addressing previous gaps in behavioral coverage. The model training may apply specific sampling strategies that account for the mixed nature of the dataset, potentially weighting real examples more heavily while using synthetic data to ensure comprehensive behavioral coverage.

The synthetic data generation method illustrated in FIG. 5 addresses the challenge of limited real-world examples for rare drowsiness behaviors through an efficient, quality-controlled process. The VLM-based search capability enables mining of existing data resources, while the flexible generation approach handles different behavioral synthesis requirements. The iterative quality validation ensures only high-quality synthetic examples enhance the training data, enabling creation of comprehensive datasets that improve model robustness for critical safety-related behaviors.

In some implementations, the system employs video-to-video generation techniques to create synthetic training data that augments real-world drowsiness behavior examples. Video-to-video generation leverages generative adversarial networks (GANs) or diffusion models trained to transform source video content while preserving temporal coherence and realistic motion patterns. The system can take existing video footage of drivers in alert states and apply learned transformations to introduce drowsiness-related behaviors such as progressive eye closure, head nodding patterns, or postural slumping. These transformations maintain the photorealistic appearance of the original footage while synthesizing behavioral indicators that may be underrepresented in naturally collected data. The video-to-video generation approach is particularly valuable for creating diverse examples of gradual drowsiness onset, where the model can generate smooth temporal transitions from alert to fatigued states across extended video sequences.

Style and pose transfer techniques provide additional mechanisms for synthetic data augmentation. Style transfer methods enable the system to adapt drowsiness behavior examples across different cabin environments, lighting conditions, and camera perspectives by transferring the visual style of target deployment scenarios onto existing behavioral examples. For instance, behavioral footage captured in well-lit daytime conditions can be style-transferred to simulate nighttime cabin illumination, creating training examples for challenging low-light detection scenarios. Pose transfer techniques allow the system to adapt detected drowsiness behaviors across different driver body types, seating positions, and anthropometric characteristics. The system can extract the skeletal pose and motion patterns from a source drowsiness example and transfer these behavioral patterns onto target driver representations, effectively creating new training examples that maintain the essential drowsiness indicators while varying the physical characteristics of the simulated driver. This approach addresses the challenge of achieving robust detection performance across diverse driver populations without requiring exhaustive real-world data collection from every demographic segment.

In addition to purely synthetic generation approaches, some implementations incorporate data crowdsourcing methodologies that engage hundreds of real human actors to imitate and record drowsiness-related behaviors under controlled conditions. The crowdsourcing system provides actors with detailed behavioral specifications describing the target drowsiness indicators, including specific guidance on yawning duration and mouth opening patterns, head drooping angles and rates of motion, eye closure timing and frequency patterns, and postural changes associated with fatigue onset. Actors perform these behaviors while being recorded by camera systems that replicate the mounting positions, fields of view, and image quality characteristics of deployed dashcam devices. The crowdsourcing approach enables systematic collection of behavioral examples that may occur infrequently in natural driving contexts, such as extreme fatigue states or specific behavior combinations. The controlled recording environment ensures consistent data quality, comprehensive metadata annotation, and the ability to capture multiple variations of each behavioral pattern. The human-acted behavioral data provides ground truth examples with known behavior labels and timing, facilitating supervised training of detection models. Furthermore, the crowdsourced data collection can be systematically designed to ensure balanced representation across demographic factors such as age, gender, ethnicity, and the presence of facial accessories like eyeglasses or facial hair, addressing potential algorithmic bias concerns and ensuring equitable detection performance across diverse driver populations. The combination of video-to-video generation, style and pose transfer, and crowdsourced actor recordings creates a comprehensive training data ecosystem that supplements naturally occurring drowsiness examples with diverse, high-quality synthetic and controlled data.

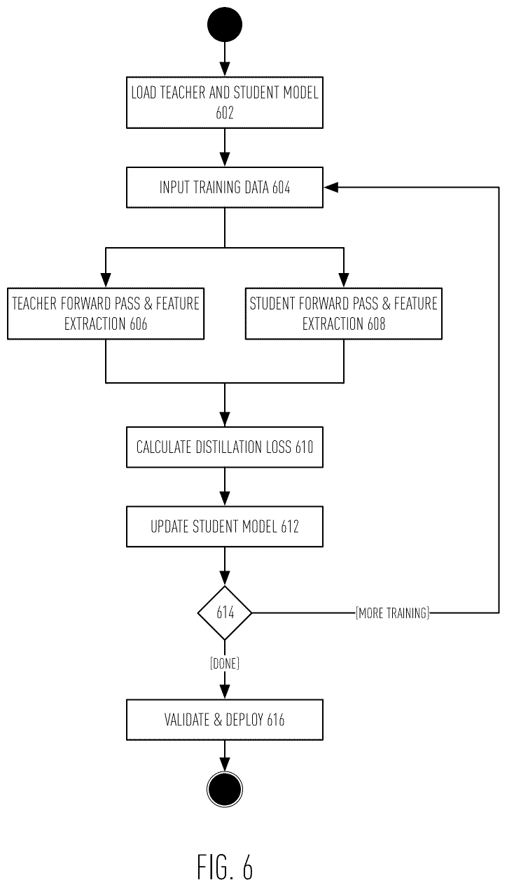

FIG. 6 is a flow diagram illustrating a method for knowledge distillation to compress drowsiness detection models for edge deployment according to some of the disclosed embodiments.

In step 602, the method begins by loading both teacher and student models for the distillation process. In some implementations, the teacher model comprises a large, high-capacity neural network that has been trained on extensive drowsiness detection datasets to achieve state-of-the-art performance. This teacher model may utilize architectures such as large transformer-based networks, deep convolutional neural networks with hundreds of layers, or ensemble models that combine multiple specialized detectors. The teacher model's size and computational requirements typically make it unsuitable for deployment on resource-constrained edge devices within vehicles, necessitating the knowledge distillation process. For example, the teacher model might require several gigabytes of memory and high-end GPU processing capabilities that exceed the specifications of embedded automotive processors. The student model architecture is specifically designed for edge deployment, with considerations for memory constraints, power consumption, and real-time processing requirements. The student model may employ efficient architectural patterns such as depthwise separable convolutions, inverted residual blocks, or quantization-friendly operations. While the teacher model might contain 100 million parameters or more, the student model typically targets an order of magnitude reduction, aiming for 5-10 million parameters that can fit within edge device constraints while maintaining acceptable accuracy. In some implementations, the teacher and student models can comprise the same basic architecture, while in other implementations the teacher and student models may be different architectures. In some implementations, the teacher model may comprise a foundational model such as a vision language model.

In step 604, the method inputs training data comprising images and videos relevant to drowsiness detection. In some implementations, this training data includes both real-world captures from vehicle-mounted cameras and synthetic data generated through the processes described in FIG. 5. The training data encompasses diverse driving scenarios, lighting conditions, driver demographics, and behavioral patterns to ensure the student model learns robust representations. The data loading process may implement batching strategies optimized for the parallel processing of teacher and student models, with batch sizes balanced between memory efficiency and gradient stability.

In step 606, the method performs a forward pass through the teacher model and extracts relevant features. In some implementations, this forward pass processes each batch of images through the teacher's complete architecture, activating all layers and computational pathways. During this forward pass, the teacher model generates internal representations at various network depths, from low-level feature maps capturing edges and textures to high-level semantic representations encoding behavioral patterns. The forward pass operates in evaluation mode with disabled dropout and batch normalization in inference state, ensuring consistent and reproducible outputs that serve as distillation targets. Feature extraction targets layers that have been identified as particularly informative for the drowsiness detection task. These might include middle-layer representations that capture facial expressions, head pose encodings, or temporal pattern features. The extraction points are strategically selected to provide the student model with rich supervisory signals beyond just the final predictions. For instance, features might be extracted from the last layer of each residual block in a ResNet-style architecture, or from the attention layers in a transformer-based model, capturing both local and global contextual information. The teacher's final predictions include multiple output heads corresponding to different aspects of drowsiness detection, such as yawning classification probabilities, eye closure regression values, head pose angles, and overall drowsiness scores. The teacher predictions are generated as continuous probability distributions or regression values rather than hard classifications, preserving the nuanced uncertainty information that helps the student learn more effectively. The predictions may be temperature-scaled to soften the probability distributions, revealing more information about the teacher's internal confidence rankings among different classes.

In step 608, the method performs a forward pass through the student model and extracts corresponding features. In some implementations, the student forward pass must process the identical images that were provided to the teacher, ensuring aligned learning targets. Despite the student's smaller architecture, it attempts to process the input through analogous computational stages, though with fewer parameters and simplified operations. The student's forward pass represents the core learning iteration where its parameters are adjusted to better approximate the teacher's behavior. The student feature extraction points are architecturally aligned with the teacher extraction points, though the feature dimensions may differ due to the student's compressed architecture. For example, where the teacher might generate 2048-dimensional feature vectors, the student might produce 256-dimensional representations that must still capture the essential information. The feature extraction includes proper normalization to ensure comparable scales between teacher and student representations despite their dimensional differences. The student predictions follow the same format as the teacher predictions, with identical output heads for various drowsiness indicators. The student predictions initially exhibit significant divergence from the teacher predictions due to random initialization or pre-training on different tasks. The knowledge distillation process progressively aligns these predictions through iterative optimization.

In step 610, the method calculates the distillation loss based on the selected knowledge distillation approach. In some implementations, the method may apply output space distillation, feature space distillation, or a combination of both. For output space distillation, the comparison focuses on aligning the probability distributions produced by the two models for each drowsiness-related classification task. The comparison quantifies how closely the student's predictions match the soft targets provided by the teacher, which contain richer information than hard labels about the relative likelihood of different behavioral states. The Kullback-Leibler (KL) divergence loss measures the information lost when using the student's predictions to approximate the teacher's predictions. The loss calculation may apply temperature scaling to both distributions, with higher temperatures revealing more about the teacher's uncertainty and providing smoother gradients for student learning. For multi-task scenarios with multiple output heads, separate KL losses are computed for each task and combined with task-specific weights reflecting their relative importance for drowsiness detection. For feature space distillation, the comparison aligns the internal feature spaces learned by both models, encouraging the student to develop similar representational structures. The feature comparison may require dimensional projection when teacher and student features have different sizes, using learned linear transformations to map between feature spaces while preserving essential information. The Mean Squared Error (MSE) loss provides a direct measure of representational similarity in the feature space. The loss calculation may include normalization factors to account for different feature scales and may apply layer-specific weights based on the importance of different representational levels. Features from earlier layers might receive lower weights as they capture more generic visual patterns, while later layers encoding behavior-specific patterns receive higher weights. For combined distillation, a comprehensive approach provides the richest supervisory signal for student learning, leveraging both the final predictions and intermediate representations. The combined loss balances the KL divergence from output space distillation with the MSE loss from feature space distillation. The combination may use learned or heuristically determined weights that evolve during training to emphasize different aspects of knowledge transfer at different training stages.

In step 612, the method updates the student model parameters based on the calculated distillation losses. In some implementations, the update process employs gradient descent optimization with carefully tuned learning rates that account for the indirect nature of distillation-based learning. The optimization may use adaptive learning rate schedules that begin with larger updates to quickly align the student with teacher behavior, then reduce learning rates for fine-tuning. Advanced optimization techniques such as momentum, Adam, or AdamW may be employed to navigate the complex loss landscape created by knowledge distillation objectives.

In step 614, the method evaluates whether additional training iterations are required. This continuation check ensures complete passes through the training data, allowing the student model to observe the full range of drowsiness-related behaviors and scenarios. When additional training is needed, the method returns to step 604 to process the next batch, continuing the iterative refinement of the student model.

When training is complete, in step 616, the method validates the student model's performance and deploys it to edge devices. In some implementations, validation assesses not only the student's absolute accuracy on drowsiness detection tasks but also its calibration, latency characteristics, and resource consumption. The validation may compare the student's performance against both the teacher model and predetermined threshold requirements for edge deployment. Specific metrics might include detection accuracy for various drowsiness behaviors, false positive rates under different lighting conditions, and processing time per frame on target edge hardware. Acceptable performance requires maintaining at least 95% of the teacher's accuracy while achieving the required compression ratios and latency targets. The criteria may specify behavior-specific thresholds, ensuring that critical safety-related detections like microsleep maintain particularly high accuracy even if less critical behaviors show slightly degraded performance. If performance criteria are not met, the knowledge distillation configuration may be adjusted, including modifying the temperature parameters for softer probability targets, changing the relative weights between output and feature space losses, adding additional feature extraction points, or adjusting the learning rate schedule. The adjustment strategy may be guided by analysis of specific failure modes, such as poor performance on particular drowsiness behaviors or excessive false positives under challenging conditions. When performance criteria are satisfied, deployment includes additional optimization steps such as quantization to int8 precision, graph optimization for specific edge processors, and integration with the edge device's existing software stack. The deployed model maintains the capability to detect the full range of drowsiness behaviors while operating within the computational constraints of automotive-grade embedded systems.

The knowledge distillation method illustrated in FIG. 6 enables the deployment of sophisticated drowsiness detection capabilities on resource-constrained edge devices without sacrificing safety-critical performance. The flexible distillation framework accommodates various architectural choices and optimization objectives. The iterative refinement process ensures that the compressed models meet stringent deployment requirements while preserving the nuanced behavioral understanding developed by large-scale teacher models. This compression technology is essential for enabling real-time, in-vehicle drowsiness detection that can prevent accidents without relying on cloud connectivity or high-end computing resources.

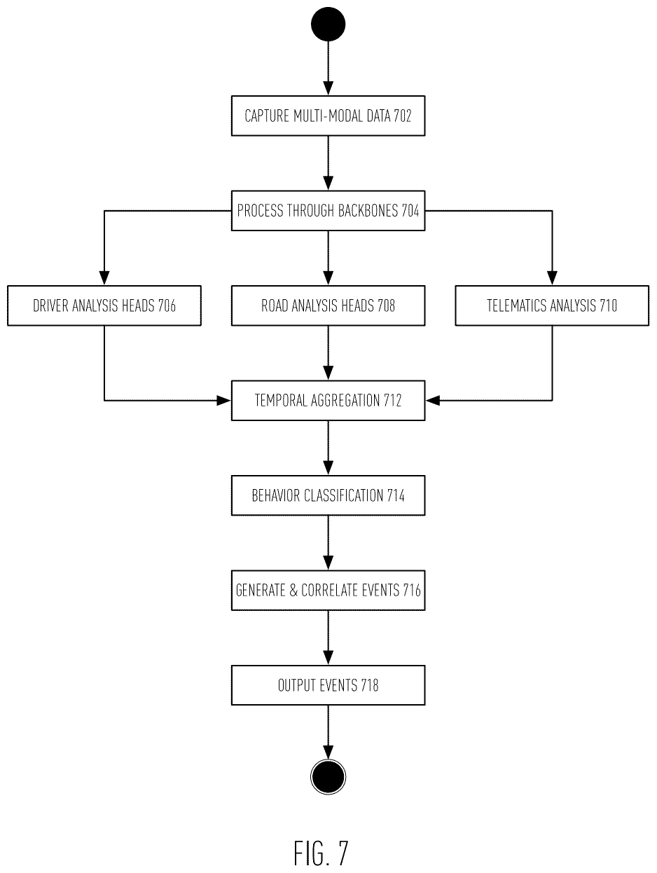

FIG. 7 is a flow diagram illustrating a method for multi-modal processing of driver, road, and vehicle data for comprehensive drowsiness detection according to some of the disclosed embodiments.

The method begins at step 702 with multi-modal data capture that provides complementary perspectives on driver state and vehicle operation. In some implementations, the system simultaneously captures driver-facing (DF) video from a camera positioned to observe the vehicle cabin interior, road-facing (RF) video from a forward-looking camera, and telematics data from the vehicle's sensor network. The driver-facing video stream provides continuous visual monitoring of the driver's facial expressions, head movements, body posture, and interactions with cabin objects. The driver-facing camera may operate at frame rates between 15-30 frames per second, with resolution sufficient to capture fine-grained behavioral details such as eye movements and subtle facial expressions. The video capture may include infrared illumination capabilities for maintaining visibility during nighttime driving conditions. The road-facing video stream monitors the vehicle's position relative to lane markings, proximity to other vehicles, and overall trajectory stability. The road-facing camera typically employs a wider field of view to capture peripheral lane boundaries and adjacent traffic, enabling comprehensive assessment of vehicle control quality. The synchronization between driver-facing and road-facing video streams enables correlation analysis between driver behaviors and vehicle performance. The telematics data includes time-series measurements of vehicle speed, acceleration, braking pressure, steering wheel angle, and other operational parameters sampled at frequencies ranging from 10-100 Hz. This high-frequency sampling captures subtle variations in vehicle control that may indicate driver impairment before visual symptoms become apparent. The telematics capture may interface with the vehicle's Controller Area Network (CAN) bus or On-Board Diagnostics (OBD-II) port to access standardized vehicle signals.

In step 704, the captured data streams are processed through specialized backbone networks designed for their respective modalities. In some implementations, the DF backbone processes driver-facing video frames through a convolutional neural network architecture optimized for human behavior analysis. This backbone may comprise architectures such as two-dimensional convolutional neural networks (CNNs) including ResNet or EfficientNet, or three-dimensional CNNs and video transformers designed for spatiotemporal analysis. When employing two-dimensional CNNs, the backbone may be pre-trained on large-scale facial analysis datasets and fine-tuned for driver monitoring tasks, extracting hierarchical features progressing from low-level edges and textures to high-level semantic representations of facial configurations and body poses. When employing three-dimensional CNNs or video transformers, the backbone processes multiple consecutive frames simultaneously, applying convolutional or attention operations across both spatial dimensions and the temporal dimension to learn motion patterns and behavioral evolution directly from video sequences. The RF backbone processes road-facing video through a network architecture specialized for scene understanding and object detection. This backbone may employ two-dimensional or three-dimensional architectures designed for autonomous driving applications, with capabilities for lane detection, vehicle tracking, and spatial relationship modeling. The backbone generates feature maps that encode the vehicle's environmental context and driving scenario. The telematics processing analyzes the time-series sensor data to extract meaningful patterns and anomalies. This processing may employ recurrent neural networks, temporal convolutional networks, or transformer architectures designed for sequence modeling. The processing identifies patterns such as steering corrections, speed variations, and braking behaviors that deviate from smooth, controlled driving.

In step 706, the method implements behavioral analysis that operates on outputs from the DF backbone. In some implementations, the behavioral analysis may be performed through multiple specialized detection heads that process extracted features, or through integrated temporal models that directly classify behaviors from spatiotemporal representations. When implemented through specialized heads, these include a pre-drowsy behavior detection head that identifies early warning signs of fatigue such as yawning, eye rubbing, face touching, stretching, and other actions that commonly precede more severe drowsiness symptoms. The pre-drowsy head may employ multi-class classification to distinguish between different precursor behaviors, enabling nuanced tracking of fatigue progression. A gaze analysis head monitors eye state and gaze direction, performing continuous estimation of eye openness percentages, blink frequency, blink duration, and gaze vectors. The gaze analysis enables detection of heavy eyelids, prolonged closures, and the thousand-yard stare associated with highway hypnosis. Advanced implementations may track saccadic eye movements and fixation patterns that change with drowsiness. A face pose head estimates the three-dimensional orientation and position of the driver's face, predicting Euler angles (pitch, yaw, roll) and translation vectors that describe head position relative to a canonical driving posture. The face pose information enables detection of head nodding, slumping, and other postural changes associated with fatigue. A face orientation classification head categorizes the general direction of driver attention into discrete categories such as looking straight ahead, looking left, looking right, looking up, or looking down. While related to face pose, this categorical classification provides rapid assessment of whether the driver's attention is directed appropriately for the driving task. An object detection head specialized for cabin environment analysis detects and localizes common objects that drivers might interact with, including mobile phones, beverages, food items, documents, and vehicle controls. The object detection enables disambiguation between drowsiness-related behaviors and purposeful activities, preventing false positive alerts when drivers intentionally look down to adjust controls or check instruments. When implemented through integrated temporal models, the behavioral analysis directly processes spatiotemporal features to classify drowsiness-related behaviors without separate detection heads for each behavior type.

In step 708, the method implements road scene analysis that processes outputs from the RF backbone. In some implementations, similar to driver behavioral analysis, road scene analysis may employ specialized detection heads or integrated processing. When using specialized heads, a lane detection head identifies and tracks lane boundary markings, outputting polynomial coefficients or point sequences describing the lane boundaries, enabling precise measurement of the vehicle's position within its lane. The lane detection supports identification of lane drift and weaving patterns associated with drowsy driving. A vehicle detection head identifies and tracks other vehicles in the road scene, providing bounding boxes and tracking IDs for surrounding vehicles, enabling assessment of following distances and relative motion patterns. Drowsy drivers often exhibit inconsistent following distances and delayed reactions to leading vehicle movements. A distance estimation head predicts metric distances to detected objects, employing monocular depth estimation techniques or leveraging known camera calibration parameters to estimate real-world distances. Accurate distance estimation enables quantitative assessment of safety margins and reaction times. When using integrated processing, the road scene analysis directly processes spatiotemporal features to detect lane drift, vehicle proximity changes, and trajectory anomalies indicative of degraded vehicle control.

In step 710, the method performs comprehensive telematics analysis on the vehicle sensor data streams. In some implementations, speed analysis identifies patterns indicative of drowsiness, detecting gradual speed decay as drivers lose focus, sudden speed corrections when they realize their inattention, and inability to maintain consistent speeds on highways. The analysis may compute metrics such as speed variance, unintentional deceleration events, and correlation between speed changes and road conditions. Braking analysis examines patterns for signs of delayed reactions or inappropriate braking force. Drowsy drivers may exhibit delayed braking responses to traffic situations, panic braking when suddenly realizing proximity to other vehicles, or absence of smooth modulation in braking pressure. The analysis may track metrics such as time-to-brake after stimulus appearance, maximum deceleration rates, and braking smoothness coefficients. Steering analysis examines patterns for indicators of reduced vehicle control. Drowsy drivers exhibit characteristic steering behaviors including reduced frequency of minor corrections, followed by large corrective movements when lane departure becomes apparent. The analysis may compute metrics such as steering entropy, power spectral density of steering signals, and steering reversal rates that quantify control quality.

All detection outputs converge at step 712, where the method performs temporal aggregation that combines information across time and modalities. In some implementations, the temporal aggregator maintains sliding windows of detection results, enabling pattern recognition that spans multiple seconds or minutes. The aggregator may employ recurrent networks, temporal convolution, or attention mechanisms to model temporal dependencies. For instance, the aggregator might recognize that a sequence of yawning, followed by head drooping, combined with increased lane position variance, provides stronger evidence of drowsiness than any individual indicator. In implementations where behavioral analysis and road scene analysis employ integrated temporal processing, the temporal aggregation in this step focuses primarily on multi-modal fusion across the three data streams rather than temporal pattern recognition within individual streams.

In step 714, the method performs behavior classification based on the temporally aggregated multi-modal features. In some implementations, this classification goes beyond simple drowsiness detection to categorize specific fatigue-related behavioral patterns. Classifications might include “early fatigue with maintained control,” “moderate drowsiness with degraded attention,” or “severe fatigue with immediate intervention required.” The classification leverages the rich multi-modal context to provide nuanced assessment beyond binary drowsy/alert determinations.

In step 716, the method generates and correlates events based on the behavior classification results. In some implementations, event generation applies configurable thresholds and temporal constraints to ensure stable, actionable outputs. Events encode the behavior type, confidence level, contributing factors from each modality, and temporal extent. The event generation may implement hysteresis to prevent rapid oscillation between states and ensure that brief detection gaps don't fragment continuous behavioral episodes. When multiple events are detected, correlation analysis examines temporal proximity, causal relationships, and known behavioral patterns. For example, the system might correlate a yawning event with subsequent microsleep, or link degraded lane keeping with coincident eye closure events. The correlation process may employ rule-based logic, probabilistic graphical models, or learned correlation patterns. Complex behaviors represent higher-order patterns that emerge from multiple coordinated indicators. Examples include “fighting sleep” (repeated yawning with effortful eye opening), “highway hypnosis” (stable lane keeping with fixed gaze and reduced steering activity), or “recovery from microsleep” (sudden head jerk with overcorrection in steering). These complex behavior descriptors provide richer context for safety interventions and driver coaching. Single events are processed as simple behaviors that can be directly interpreted without additional context, including isolated yawns, brief eye closures, or temporary lane drifts that don't form part of larger patterns. While less severe than complex behaviors, simple behaviors still contribute to overall fatigue assessment and may trigger graduated responses.

In step 718, the method consolidates all generated events into a unified output format. In some implementations, the output includes structured event records with timestamps, behavior classifications, severity scores, contributing evidence from each modality, and recommended responses. The events may be prioritized based on safety criticality, with severe fatigue indicators taking precedence for immediate alerts.

The multi-modal processing method illustrated in FIG. 7 provides comprehensive drowsiness detection by leveraging complementary information sources. The parallel processing architecture enables real-time analysis despite the computational complexity of multiple neural networks. The flexible implementation approach—whether through specialized detection heads with separate temporal aggregation or integrated spatiotemporal processing—enables optimization for different computational constraints and performance requirements. The behavioral analysis extracts relevant drowsiness indicators while the temporal aggregation captures evolving behavioral patterns. The correlation analysis reveals complex fatigue manifestations that might be missed by simpler approaches. This holistic processing ensures robust, nuanced drowsiness detection that can adapt to individual driver characteristics and diverse driving scenarios.

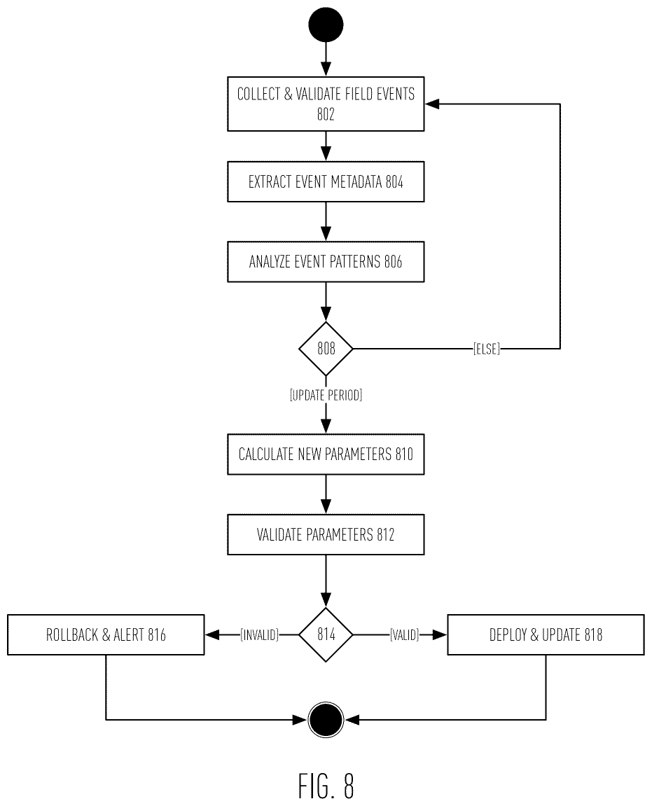

FIG. 8 is a flow diagram illustrating a method for parameter update and continuous improvement of drowsiness detection systems according to some of the disclosed embodiments.

In step 802, the method begins by collecting field events from deployed drowsiness detection systems across a vehicle fleet and implementing human validation. In some implementations, field events comprise drowsiness detections generated by edge devices during actual driving operations, including associated metadata such as timestamps, GPS locations, weather conditions, driver identifiers, and video evidence. The collection process may aggregate events from hundreds or thousands of vehicles operating in diverse geographic regions and driving conditions. Events are transmitted from edge devices to cloud infrastructure when network connectivity permits, with local buffering to handle intermittent connections. The collected events represent real-world system outputs that serve as the foundation for validating and improving detection algorithms. Trained safety analysts review video footage and sensor data associated with each drowsiness event to determine whether the detection accurately identified driver fatigue. The validation interface may present synchronized multi-modal data including driver-facing video showing the detected behavior, road-facing video showing vehicle control quality, and telematics graphs displaying speed and steering patterns. Validators assess whether the observed behaviors genuinely indicate drowsiness or represent false positives triggered by normal activities. The validation process may employ multiple reviewers for ambiguous cases, with consensus mechanisms to resolve disagreements. The validation determines whether each event represents a true positive detection based on the human validator's assessment using established criteria for drowsiness behaviors. True positive events are those where the system correctly identified genuine drowsiness indicators such as sustained eye closure, head drooping without purposeful activity, or characteristic patterns of degraded vehicle control. The validation decision may include confidence ratings that reflect the clarity of drowsiness evidence, enabling nuanced analysis beyond binary classifications. For events validated as true positives, they are added to a batch for parameter optimization. The batching process accumulates validated events until sufficient data is available for statistically meaningful parameter updates. Batch sizes may be configured based on the desired update frequency and the rate of event generation across the fleet. The batching system maintains separate queues for different event types, ensuring balanced representation of various drowsiness behaviors in the optimization process. For events identified as false positives, they are marked with appropriate metadata for error analysis. False positive marking includes categorization of the error type, such as “object interaction misclassified as drowsiness,” “normal blinking interpreted as eye closure,” or “intentional head movement confused with drooping.” These error categorizations guide targeted improvements to reduce specific types of misdetections. The false positive data is retained rather than discarded, providing valuable negative examples for model retraining and parameter adjustment.

In step 804, the method extracts comprehensive metadata from all validated events, regardless of their classification. In some implementations, metadata extraction compiles information about the temporal characteristics of detected behaviors, environmental conditions during detection, driver demographics if available, and system configuration parameters active during detection. For true positive events, metadata includes the specific sequence of atomic behaviors that triggered detection, their individual confidence scores, and the final Driver Fatigue Index value. For false positives, metadata captures the contributing factors that led to misclassification.

In step 806, the method analyzes event patterns through multiple statistical and sequential analyses. In some implementations, this includes counting different event types within the validation batch, generating frequency distributions for various drowsiness behaviors such as yawning, microsleep, lane drift, and complex multi-behavior patterns. The counting process may stratify results by contextual factors such as time of day, driving duration, weather conditions, and vehicle type. Comparative analysis between true positive and false positive distributions reveals which behaviors the system detects most reliably and which require parameter adjustments. Duration analysis examines how long different drowsiness behaviors persist, the temporal gaps between related behaviors, and the total duration from first warning signs to severe drowsiness. For example, the analysis might reveal that validated yawning events average 4.2 seconds while false positive yawns average only 2.1 seconds, suggesting the duration threshold could be adjusted. Duration calculations may produce percentile distributions rather than simple averages, capturing the full range of behavioral variations. Sequence analysis employs pattern mining algorithms to identify common progressions of atomic events such as “yawning→eye rubbing→microsleep” or “head drooping→lane drift→sudden correction.” The analysis quantifies transition probabilities between different behaviors and identifies sequence patterns that strongly predict impending severe drowsiness. Sequence mining may reveal that certain behavior combinations provide higher predictive value than individual indicators, informing adjustments to event correlation logic. Historical analysis compares current validation results with long-term trends, tracking how detection performance has evolved across multiple parameter update cycles, identifying whether recent changes have improved or degraded accuracy. The historical perspective reveals seasonal patterns, driver adaptation effects, and the impact of vehicle technology changes on detection reliability. Long-term trending may show, for instance, that false positive rates for nighttime detections have steadily decreased while daytime detection sensitivity has remained stable.

In step 808, the method determines whether the configured update period has been reached. In some implementations, update periods balance the need for system stability with continuous improvement, typically ranging from weekly to monthly cycles depending on fleet size and event generation rates. The update trigger may be based on calendar time, accumulated event counts, or detection of significant performance drift. Some implementations may employ adaptive update scheduling that increases frequency when validation results indicate degraded performance. When the update period has not been reached, the method returns to step 802 to continue collecting and validating events. This continuous collection ensures that parameter updates are based on comprehensive, recent operational data rather than limited snapshots.

When the update period triggers, in step 810, the method calculates new parameters including weights, decay factors, and thresholds. In some implementations, the current operational parameters are loaded from the system database, including behavior-specific detection thresholds, temporal correlation windows, weighting factors for different indicators, decay rates for the fatigue index, and contextual adjustment factors. The parameter loading creates a baseline for calculating incremental improvements while maintaining continuity with the deployed system configuration. Weight calculation employs optimization algorithms that adjust the relative importance of different behaviors to maximize true positive rates while minimizing false positives. For instance, if validation reveals that head drooping events have high precision but yawning events generate many false positives, the optimization might increase head drooping weight while reducing yawning weight. The calculation may employ gradient-based optimization, genetic algorithms, or Bayesian optimization to navigate the multi-dimensional parameter space. Decay calculation analyzes the temporal gaps between validated drowsiness behaviors to determine appropriate memory horizons. If sequence analysis shows that drowsiness indicators typically cluster within two-minute windows, decay rates might be adjusted to maintain higher influence within this period while decaying more rapidly afterward. Different decay rates may be calculated for different behavior types based on their temporal persistence patterns. Threshold updates target the decision boundaries for individual behavior detectors and the overall fatigue index. For example, if eye closure detections show clear separation between true positives averaging 3.1 seconds and false positives averaging 1.8 seconds, the threshold might be adjusted from 2.5 to 2.4 seconds to capture more true events while maintaining false positive control. Threshold optimization may employ ROC curve analysis to find optimal operating points for different deployment scenarios.

In step 812, the method validates the newly calculated parameters through simulation or limited testing. In some implementations, validation replays historical event data through the detection system using both old and new parameters, comparing detection outcomes. The validation ensures that parameter changes improve overall system performance without introducing unexpected side effects. Specific validation checks might include ensuring no single parameter changed by more than 20% to maintain system stability, and verifying that true positive rates improve or remain stable for all major behavior categories.

In step 814, the method determines whether the validated parameters meet acceptance criteria. In some implementations, acceptance requires improvements in key metrics such as overall F1 score, maintenance of minimum per-behavior detection rates, and absence of significant false positive increases for any driving context. The criteria may be stratified by deployment criticality, with stricter requirements for parameters that will affect safety-critical alerting thresholds.

When parameters fail validation, in step 816, the method implements rollback procedures and alerts administrators. In some implementations, rollback maintains the current operational parameters while logging the failed update attempt for investigation. The system alerts administrators about the rollback event, providing detailed analysis of which validation criteria failed. The alert may include recommendations for manual parameter adjustment or identification of data quality issues requiring attention. Manual review procedures are initiated where human experts analyze the failed parameter update to understand root causes. Manual review examines whether validation failures indicate fundamental changes in driver behavior patterns, vehicle technology evolution, or data distribution shifts that require algorithmic updates beyond simple parameter tuning. The review may recommend model retraining, architecture modifications, or adjustments to the validation criteria themselves.

When parameters pass validation, in step 818, the method deploys the updates and notifies relevant stakeholders. In some implementations, deployment uses staged rollout strategies, initially updating a small percentage of vehicles to monitor real-world performance before fleet-wide deployment. The deployment system ensures atomic parameter updates to prevent inconsistent configurations and maintains version tracking for potential rollbacks. The central parameter database is updated with the new validated configuration, including comprehensive metadata about the optimization process, the validation results that led to these parameters, the historical parameters they replace, and traceability to the specific events that influenced each change. This detailed record enables post-deployment analysis and supports regulatory compliance for safety-critical systems. Fleet managers and safety personnel are notified about the parameter updates through notifications that include summaries of expected performance improvements, any changes to alert sensitivity that drivers might notice, and guidance for monitoring the updated system. The notifications may be customized based on fleet-specific configurations, highlighting parameters that particularly affect their operational scenarios.

The parameter update method illustrated in FIG. 8 creates a continuous learning loop that improves drowsiness detection accuracy based on real-world performance. The human validation ensures that system improvements are grounded in genuine safety outcomes rather than just algorithmic metrics. The systematic parameter optimization balances multiple objectives while maintaining system stability. The comprehensive validation and rollback mechanisms protect against degraded configurations reaching production. This continuous improvement cycle enables the drowsiness detection system to adapt to evolving driver behaviors, vehicle technologies, and operational contexts while maintaining the reliability required for safety-critical applications.

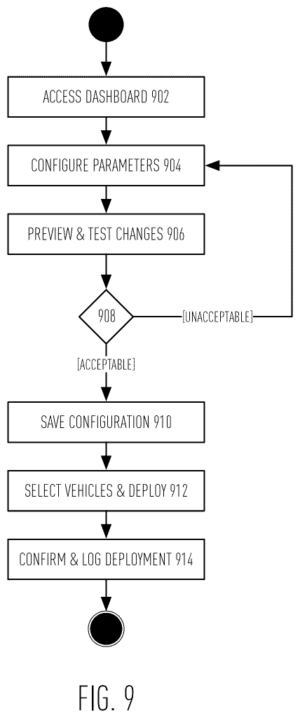

FIG. 9 is a flow diagram illustrating a method for fleet configuration of drowsiness detection systems according to some of the disclosed embodiments.

In step 902, the method begins with accessing the fleet management dashboard after authentication. In some implementations, the login process implements multi-factor authentication to ensure that only authorized personnel can modify safety-critical drowsiness detection parameters. The authentication may require corporate credentials combined with role-based permissions that determine which configuration options are accessible to different user types. For instance, fleet safety managers might have full configuration access, while regional supervisors might be limited to adjusting alert preferences without modifying core detection parameters. The dashboard presents a comprehensive overview of the current drowsiness detection system status across the vehicle fleet, including active configuration profiles, recent detection statistics, and any pending parameter updates from the continuous improvement system described in FIG. 8. The dashboard interface may organize information hierarchically, allowing managers to view fleet-wide summaries or drill down to specific vehicle groups, regions, or individual drivers. Real-time status indicators show which vehicles are currently operating with which configuration versions, enabling managers to understand the current deployment state before making changes.

In step 904, the user configures various parameters through the management interface. In some implementations, the configuration interface presents categories of adjustable parameters organized by their functional impact on the drowsiness detection system. The interface may provide guided workflows for common configuration scenarios such as “increase sensitivity for night shift operations” or “reduce false positives for urban delivery routes.” The configuration system separates different aspects of drowsiness detection behavior to enable targeted adjustments without requiring deep technical knowledge of the underlying algorithms. For sensitivity configuration, threshold adjustments are presented through intuitive interfaces such as sliding scales ranging from “less sensitive” to “more sensitive” rather than raw numerical values. Behind this simplified interface, the system translates sensitivity adjustments into specific parameter modifications such as reducing the required eye closure duration from 2.5 to 2.0 seconds for earlier detection, or increasing the yawning frequency threshold from 2 to 3 events to reduce false positives. The interface may provide scenario-based examples showing how different sensitivity settings would affect detection in common situations. For behavior configuration, the system allows enabling or disabling specific drowsiness indicators to address fleet-specific needs where certain behaviors may not be reliable indicators due to operational contexts. For example, a fleet operating in urban environments with frequent stops might disable lane drift detection to avoid false positives from legitimate lane changes, while maintaining full sensitivity for direct driver monitoring features. The behavior selection interface may group related behaviors and show dependency warnings when disabling certain indicators might compromise overall detection effectiveness. For decay configuration, the interface provides control over how quickly the influence of detected behaviors diminishes over time. Decay rate adjustments allow fleets to balance between maintaining appropriate alertness memory and avoiding persistent alerts from isolated incidents. Longer decay periods might be appropriate for long-haul trucking where fatigue accumulates over hours, while shorter decay periods might suit urban delivery operations with natural break points. The decay configuration interface may visualize the temporal impact of different settings using example scenarios showing how alert patterns would change. For alert configuration, the system customizes how it responds when drowsiness is detected, encompassing multiple modalities including audio warning patterns, visual display preferences, haptic feedback intensity, and escalation sequences for increasing severity. Fleet managers can configure whether alerts are delivered only to drivers, simultaneously to fleet dispatch centers, or with delayed reporting for driver privacy. The configuration may include culture-specific adaptations such as language selection for voice alerts and appropriate warning tone selections that are noticeable without being startling.

In step 906, the method provides preview and testing capabilities for the configuration changes. In some implementations, the preview interface displays side-by-side comparisons of current and proposed configurations, highlighting specific parameters that will change. The preview may include estimated impacts such as “approximately 15% increase in nighttime drowsiness detections” or “expected 20% reduction in false positive alerts during stop-and-go traffic.” Visual representations show how the detection sensitivity curves shift with the proposed changes, helping managers understand the practical implications before deployment. The testing capability allows managers to validate configuration changes against historical driving data or synthetic test scenarios. This testing option is particularly valuable for significant configuration changes that might substantially alter system behavior, allowing managers to verify that changes achieve intended goals without unintended consequences. The simulation system replays historical event data through the detection algorithms using both current and proposed parameters, generating comparative results. The simulation may use a representative sample of driving scenarios from the fleet's actual operations, including various times of day, weather conditions, and driver populations. For comprehensive testing, the simulation might process thousands of hours of historical data, completing in minutes what would take weeks to observe in actual operations. For minor configuration changes such as alert volume adjustments or language selections that may be deemed low-risk, the system may provide an option to skip detailed testing while still showing the preview.

In step 908, the method evaluates whether the preview and test results meet acceptance criteria. In some implementations, results presentation includes key performance metrics such as detection rates for different drowsiness behaviors, false positive rates stratified by driving context, and projected alert frequencies for different driver groups. The results interface may highlight significant changes using color coding, with improvements shown in green and potential concerns in yellow or red. Detailed drill-down capabilities allow examination of specific scenarios where the configuration changes have the most impact. Acceptance evaluation may be partially automated, with the system flagging results that fall outside predetermined safety bounds such as detection rates dropping below regulatory minimums or false positive rates exceeding driver tolerance thresholds. The evaluation interface presents these assessments alongside the raw metrics, helping managers make informed decisions about whether to proceed with deployment. When results are not acceptable, the interface may provide specific recommendations based on the simulation results, such as “reduce sensitivity by 10% to achieve target false positive rate” or “enable microsleep detection to maintain safety standards.” This iterative refinement process allows managers to converge on optimal configurations through evidence-based adjustments rather than trial and error in production systems.

In step 910, the method saves the validated configuration to the system database. In some implementations, saving creates a versioned configuration record that includes the complete parameter set, metadata about who made the changes and why, and any simulation results that validated the configuration. The saved configuration becomes available for deployment but does not automatically propagate to vehicles, maintaining separation between configuration creation and deployment decisions.

In step 912, the method handles vehicle selection and deployment of the new configuration. In some implementations, vehicle selection supports flexible grouping by various attributes such as geographic region, vehicle type, driver seniority, shift patterns, or custom fleet-defined categories. The selection interface may recommend phased deployment strategies, suggesting initial rollout to a pilot group before fleet-wide deployment. Managers can create sophisticated selection rules such as “all long-haul trucks operating primarily at night” or “new drivers in their first 90 days of employment.” Deployment planning considers practical factors such as network connectivity windows, driver shift changes to avoid mid-trip updates, and coordination with other fleet management activities. The deployment system may queue configuration updates for vehicles currently offline, automatically applying changes when connectivity is restored. Priority mechanisms ensure that safety-critical updates propagate quickly while routine adjustments can be scheduled during maintenance windows. The update process uses secure over-the-air mechanisms to transmit new configurations to vehicle-mounted drowsiness detection systems. The update protocol ensures atomic configuration changes, preventing partial updates that might leave systems in inconsistent states. Each edge device validates received configurations before activation, rejecting updates that fail integrity checks or contain invalid parameter combinations.

In step 914, the method confirms deployment and creates comprehensive logs of all changes. In some implementations, confirmation requires positive acknowledgment from each targeted edge device, with the system tracking deployment progress in real-time. The confirmation process may include functional verification where edge devices perform self-tests with the new configuration before reporting success. Failed deployments are flagged for investigation, with automatic retry mechanisms for transient failures and escalation procedures for persistent issues. Logging captures the complete audit trail from initial configuration selection through successful deployment, including who made changes, what was changed, when changes occurred, and which vehicles were affected. The logs support regulatory compliance requirements for safety system modifications and enable investigation if configuration changes correlate with incident patterns. Log retention policies ensure that configuration history remains available for the full operational lifetime of affected vehicles. Notification procedures inform relevant stakeholders about the configuration changes. Notifications are tailored to different audiences, with technical details for maintenance teams, behavioral impact summaries for driver trainers, and high-level status updates for management. The notification system may integrate with existing fleet communication channels, ensuring that all personnel who interact with affected vehicles are aware of the drowsiness detection system modifications.

The fleet configuration method illustrated in FIG. 9 empowers fleet managers to optimize drowsiness detection systems for their specific operational needs while maintaining appropriate safety standards. The intuitive interface design allows non-technical users to make sophisticated adjustments through guided workflows and clear visualization of impacts. The simulation capability enables evidence-based configuration decisions without risking operational disruption. The flexible deployment options support gradual rollouts and targeted configurations for different operational contexts. Together, these capabilities ensure that drowsiness detection systems can be adapted to diverse fleet requirements while maintaining the reliability and effectiveness necessary for preventing fatigue-related accidents.

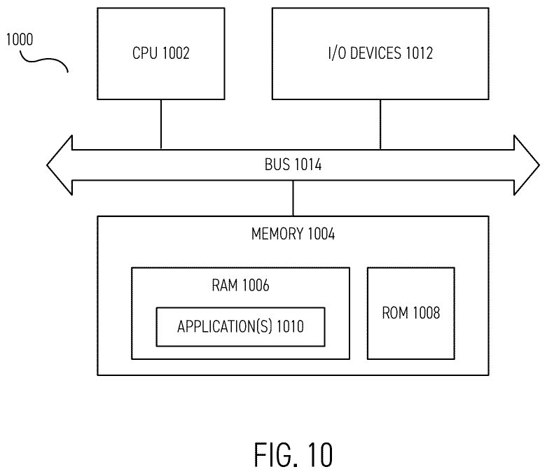

FIG. 10 is a block diagram of a computing device according to some embodiments of the disclosure.

As illustrated, the device 1000 includes a processor or central processing unit (CPU) such as CPU 1002 in communication with a memory 1004 via a bus 1014. The device also includes one or more input/output (I/O) or peripheral devices 1012. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 1002 may comprise a general-purpose processor. The CPU 1002 may comprise a single-core or multiple-core processor. The CPU 1002 may comprise a system-on-a-chip (SoC) processor or a similar embedded system or processor. In some embodiments, a graphics processing unit (GPU) may be used in place of, or in combination with, a CPU 1002. Memory 1004 may comprise a memory system including a dynamic random-access memory (DRAM), static random-access memory (SRAM), Flash (e.g., NAND Flash), or combinations thereof. In one embodiment, the bus 1014 may comprise a Peripheral Component Interconnect Express (PCIe) bus. In some embodiments, the bus 1014 may comprise multiple busses instead of a single bus.

Memory 1004 illustrates an example of a non-transitory computer storage media for the storage of information such as computer-readable instructions, data structures, program modules, or other data. Memory 1004 can store a basic input/output system (BIOS) in read-only memory (ROM), such as ROM 1008 for controlling the low-level operation of the device. The memory can also store an operating system in random-access memory (RAM) for controlling the operation of the device.

Applications 1010 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 1006 by a processor, such as CPU 1002. The CPU 1002 may then read the software or data from RAM 1006, process them, and store them in RAM 1006 again.

The device may optionally communicate with a base station (not shown) or directly with another computing device. One or more network interfaces in peripheral devices 1012 are sometimes referred to as a transceiver, transceiving device, or network interface card (NIC).

An audio interface in peripheral devices 1012 produces and receives audio signals such as the sound of a human voice. For example, an audio interface may be coupled to a speaker and microphone (not shown) to enable telecommunication with others or generate an audio acknowledgment for some action. Displays in peripheral devices 1012 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 1012 may comprise any input device arranged to receive input from a user. An illuminator in peripheral devices 1012 may provide a status indication or provide light. The device can also comprise an input/output interface in peripheral devices 1012 for communication with external devices, using communication technologies, such as USB, infrared, Bluetooth®, or the like. A haptic interface in peripheral devices 1012 provides tactile feedback to a user of the client device.

A GPS receiver in peripheral devices 1012 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 10, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A system comprising:
a telematics sensor configured to record telematics data related to a vehicle;
one or more camera sensors situated within a dash-mounted camera housing installed within the vehicle, the one or more camera sensors configured to capture video frames;
an atomic event identifier including one or more of a driver-facing perception ML module, a road-facing perception ML module, a telemetry ML module and a personalized driving context and history module; and
an edge processor situated within the dash-mounted camera housing, the edge processor configured to:
receive the video frames and the telematics data;
determine whether a vehicle speed exceeds a predetermined threshold based on an output of the telematics sensor;
when the vehicle speed exceeds the predetermined threshold, process the video frames and telematics data through the atomic event identifier to detect one or more atomic events;
calculate a Driver Fatigue Index (DFI) score by aggregating detected atomic events with configurable weights;
generate a drowsiness/fatigue event when the DFI score exceeds a configurable threshold; and
trigger an in-cab alert in response to the generated drowsiness/fatigue event.

2. The system of claim 1, wherein the atomic event identifier comprises:
a unified driver model comprising a neural network backbone configured to extract hierarchical features from driver-facing video frames;
a unified road model comprising a neural network backbone configured to extract hierarchical features from road-facing video frames;
a plurality of task-specific detection heads configured to process the hierarchical features of unified driver model, the plurality of task-specific detection heads comprising at least one of: an object detection head, a scene/action classification head, a head pose estimation head or a body pose estimation head;
a plurality of task-specific detection heads configured to process the hierarchical features of unified road model, the plurality of task-specific detection heads comprising at least one of: an object detection head, a scene classification head, depth estimation head, 3D cuboid detection, lane detection head, or segmentation head; and
a plurality of state machines configured to receive outputs from the plurality of task-specific detection heads and apply rule-based temporal logic to validate behavioral patterns across consecutive frames;
wherein the atomic events are generated based on outputs from the plurality of state machines.

3. The system of claim 1, wherein the atomic event identifier comprises:
a unified driver model comprising a neural network backbone configured to extract feature embeddings from driver-facing video frames;
a unified road model comprising a neural network backbone configured to extract feature embeddings from road-facing video frames;
a first temporal neural network configured to receive the feature embeddings from the unified driver model and classify behavioral patterns by analyzing evolution of the feature embeddings over time; and
a second temporal neural network configured to receive the feature embeddings from the unified road model and classify behavioral patterns by analyzing evolution of the feature embeddings over time;
wherein the atomic events are generated based on outputs from the temporal neural network.

4. The system of claim 1, wherein the atomic event identifier comprises:
an end-to-end trainable neural network configured to directly process video frames to generate behavioral indicator classifications, wherein the end-to-end trainable neural network employs spatiotemporal processing that simultaneously captures spatial visual patterns and temporal evolution without separate feature extraction and temporal aggregation stages.

5. The system of claim 2, wherein the plurality of state machines are configured to:
maintain tracking of atomic events across consecutive frames;
increment a respective atomic event counter when its confidence score exceeds a preconfigured threshold;
validate that the respective atomic event behavior duration exceeds a second preconfigured threshold; and
apply a voting filter requiring a threshold number of frames within the second preconfigured threshold to contain valid detections.

6. The system of claim 1, wherein calculating the DFI score comprises:
applying behavior-specific weights to each detected behavioral indicator based on correlation with fatigue-related accidents;
applying contextual factors comprising at least one of: prior driving context, trip duration, time of day, or previous atomic events; and
applying a decay function to reduce influence of past atomic events over time.

7. The system of claim 6, the edge processor further configured to:
select between at least one of linear decay calculation, an exponential decay calculation, or an ML-based decay calculation based on a configuration parameter; and
maintain different decay rates for different types of atomic events.

8. The system of claim 1, the edge processor further configured to:
record video evidence of the drowsiness/fatigue event;
upload the video evidence and event metadata to a cloud processing system;
receive updated detection parameters from the cloud processing system, the updated parameters derived from human validation of previous behavioral events; and
apply the updated detection parameters to subsequent drowsiness/fatigue detection operations.

9. The system of claim 8, the edge processor further configured to:
continuously receive real-time contextual data pertaining to an operating environment of the vehicle, the contextual data comprising at least one of: current weather conditions, time of day, road classification, vehicle speed, or traffic density; and
dynamically adjust a plurality of operational thresholds based on the received real-time contextual data,
wherein the plurality of operational thresholds includes at least a drowsiness score threshold, one or more behavioral indicator sensitivity thresholds, and an alert generation threshold.

10. The system of claim 1, the edge processor further configured to:
receive configuration updates from a fleet management system, the configuration updates specifying at least one of: detection sensitivity thresholds, enabled atomic events, decay rates, or alert modalities;
validate the configuration updates through simulation against historical event data; and
apply the validated configuration updates to modify drowsiness detection parameters without interrupting ongoing vehicle operation.

11. The system of claim 1, further comprising a cloud-based synthetic data generation system configured to:
identify atomic events having insufficient representation in training data;
search one or more data repositories using one or more machine learning models to identify content containing the identified atomic events;
generate synthetic training data for atomic events determined to have insufficient real-world examples, wherein the synthetic training data generation comprises modifying existing image or video data to introduce atomic events; and
update parameters of the atomic event identifier based on training data comprising both the identified content from the data repositories and the generated synthetic training data.

12. The system of claim 1, wherein the atomic event identifier further comprises:
a telematics processing module configured to receive time-series vehicle operational data from the telematics sensor; and
one or more state machines configured to analyze temporal patterns in the vehicle operational data to identify anomalous driving behaviors, wherein the edge processor is configured to incorporate outputs from the one or more state machines as inputs for calculating the DFI score.

13. The system of claim 12, wherein the one or more state machines are configured to:
receive longitudinal vehicle speed data over a plurality of time intervals;
analyze the received vehicle speed data to identify speed variation patterns indicative of driver fatigue, the patterns comprising at least one of: inconsistent acceleration, erratic deceleration, or failure to maintain consistent cruising speed; and
generate a speed-based fatigue metric based on the identified speed variation patterns;
wherein the edge processor utilizes the speed-based fatigue metric as an additional input to corroborate and refine the DFI score calculation.

14. A method comprising:
receiving, by an edge processor situated within a dash-mounted camera housing installed within a vehicle, video frames captured by one or more camera sensors situated within the dash-mounted camera housing and telematics data recorded by a telematics sensor of the vehicle;
determining, by the edge processor, whether a vehicle speed exceeds a predetermined threshold based on an output of the telematics sensor;
when the vehicle speed exceeds the predetermined threshold, process the video frames and telematics data through an atomic event identifier to detect one or more atomic events, the atomic event identifier including one or more of a driver-facing perception ML module, a road-facing perception ML module, a telemetry ML module and a personalized driving context and history module;
calculating, by the edge processor, a Driver Fatigue Index (DFI) score by aggregating detected atomic events with configurable weights;
generating, by the edge processor, a drowsiness/fatigue event when the DFI score exceeds a configurable threshold; and
triggering, by the edge processor, an in-cab alert in response to the generated drowsiness/fatigue event.

15. The method of claim 14, wherein the atomic event identifier comprises:
a unified driver model comprising a neural network backbone configured to extract hierarchical features from driver-facing video frames;
a unified road model comprising a neural network backbone configured to extract hierarchical features from road-facing video frames;
a plurality of task-specific detection heads configured to process the hierarchical features of unified driver model, the plurality of task-specific detection heads comprising at least one of: an object detection head, a scene/action classification head, a head pose estimation head or a body pose estimation head;
a plurality of task-specific detection heads configured to process the hierarchical features of unified road model, the plurality of task-specific detection heads comprising at least one of: an object detection head, a scene classification head, depth estimation head, 3D cuboid detection, lane detection head, or segmentation head; and
a plurality of state machines configured to receive outputs from the plurality of task-specific detection heads and apply rule-based temporal logic to validate behavioral patterns across consecutive frames;
wherein the atomic events are generated based on outputs from the plurality of state machines.

16. The method of claim 15, wherein the plurality of state machines are configured to:
maintain tracking of atomic events across consecutive frames;
increment a respective atomic event counter when its confidence score exceeds a preconfigured threshold;
validate that the respective atomic event behavior duration exceeds a second preconfigured threshold; and
apply a voting filter requiring a threshold number of frames within the second preconfigured threshold to contain valid detections.

17. The method of claim 14, wherein the atomic event identifier comprises:
a unified driver model comprising a neural network backbone configured to extract feature embeddings from driver-facing video frames;
a unified road model comprising a neural network backbone configured to extract feature embeddings from road-facing video frames;
a first temporal neural network configured to receive the feature embeddings from the unified driver model and classify behavioral patterns by analyzing evolution of the feature embeddings over time; and
a second temporal neural network configured to receive the feature embeddings from the unified road model and classify behavioral patterns by analyzing evolution of the feature embeddings over time;
wherein the atomic events are generated based on outputs from the temporal neural network.

18. The method of claim 14, wherein the atomic event identifier comprises:
an end-to-end trainable neural network configured to directly process video frames to generate behavioral indicator classifications, wherein the end-to-end trainable neural network employs spatiotemporal processing that simultaneously captures spatial visual patterns and temporal evolution without separate feature extraction and temporal aggregation stages.

19. The method of claim 14, wherein the atomic event identifier further comprises:
a telematics processing module configured to receive time-series vehicle operational data from the telematics sensor; and
one or more state machines configured to analyze temporal patterns in the vehicle operational data to identify anomalous driving behaviors, wherein the edge processor is configured to incorporate outputs from the one or more state machines as inputs for calculating the DFI score.

20. A non-transitory computer-readable storage medium for tangibly storing computer program instructions capable of being executed by an edge processor situated within a dash-mounted camera housing installed within a vehicle, the computer program instructions defining steps of:
receiving, by the edge processor, video frames captured by one or more camera sensors situated within the dash-mounted camera housing and telematics data recorded by a telematics sensor of the vehicle;
determining, by the edge processor, whether a vehicle speed exceeds a predetermined threshold based on an output of the telematics sensor;
when the vehicle speed exceeds the predetermined threshold, process the video frames and telematics data through an atomic event identifier to detect one or more atomic events, the atomic event identifier including one or more of a driver-facing perception ML module, a road-facing perception ML module, a telemetry ML module and a personalized driving context and history module;
calculating, by the edge processor, a Driver Fatigue Index (DFI) score by aggregating detected atomic events with configurable weights;
generating, by the edge processor, a drowsiness/fatigue event when the DFI score exceeds a configurable threshold; and
triggering, by the edge processor, an in-cab alert in response to the generated drowsiness/fatigue event.
